(19) United States
(12) Patent Application Publication
(10) Pub. No.: US 2006/0085923 A1
(43) Pub. Date: Apr. 27, 2006

(54) Dye composition comprising a naphthoylene-benzimidazolium direct dye, process for dyeing keratin fibers and uses thereof

(76) Inventor: Alain Lagrange, Coupvray (FR)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/241,993

(22) Filed: Oct. 4, 2005

Related U.S. Application Data
(60) Provisional application No. 60/627,167, filed on Nov. 15, 2004.

(30) Foreign Application Priority Data
Oct. 4, 2004 (FR) 04 10453

(51) Int. Cl. A61Q 5/10

(52) U.S. Cl. 8/406

(57) ABSTRACT

The present disclosure relates to a dye composition for dyeing keratin fibers, including human keratin fibers such as the hair, comprising, in a suitable dyeing medium, at least one naphthoylene-benzimidazolium direct dye. The disclosure also relates to a dyeing process using this composition, and uses thereof.

This application claims benefit of U.S. Provisional Application No. 60/627,167, and Nov. 15, 2004, the contents of which are incorporated herein by reference. This application also claims benefit of priority under 35 U.S.C. § 119 to French Patent Application No. 04 10453, filed Oct. 4, 2004, the contents of which are also incorporated by reference.

The present disclosure relates to a dye composition for dyeing keratin fibers, comprising, in a suitable dyeing medium, at least one direct dye of naphthoylene-benzimidazolium type.

It is known practice to dye keratin fibers, such as human hair, with dye compositions containing oxidation dye precursors, which are generally known as oxidation bases, such as ortho- or para-phenylenediamines, ortho- or para-aminophenols, and heterocyclic compounds. These oxidation bases are colorless or weakly colored compounds that, when combined with oxidizing products, may give rise to colored compounds by a process of oxidative condensation. These dyes, which are insoluble in the dyeing medium, are formed within the hair.

It is also known that the shades obtained with these oxidation bases may be varied by combining them with couplers or coloration modifiers, the latter being chosen, for instance, from aromatic meta-diamines, meta-aminophenols, meta-diphenols and certain heterocyclic compounds such as indole compounds.

The variety of molecules used as oxidation bases and couplers allows a wide range of colors to be obtained.

The “permanent” coloration obtained using these oxidation dyes should ideally, moreover, satisfy a certain number of requirements. Thus, it should, ideally, have no toxicological drawback, be able to produce shades in the desired intensity, and/or show good resistance to external agents such as light, bad weather, washing, permanent-waving, perspiration and rubbing.

It is also desirable for such dyes to be able to cover grey hair and, to be as unselective as possible, i.e., produce the smallest possible differences in coloration along the same keratin fiber, which is generally differently sensitized (i.e., damaged) between its end and its root.

However, the base-coupler combinations of the prior art are still not always entirely satisfactory in terms of lightness of the shades (chromaticity), fastness or selectivity.

It is also known practice to dye keratin fibers by direct or semi-permanent dyeing. The process conventionally used in direct dyeing comprises applying to the keratin fibers direct dyes, which are colored and coloring molecules with affinity for the fibers, leaving the colored molecules on the fibers to allow them to penetrate, by diffusion, into the hair, and then rinsing the fibers.

It is known practice, for example, to use nitrobenzene, anthraquinone, nitropyridine, azo, xanthene, acridine, azine or triaryl methane direct dyes.

Direct dyes may result in colorations that are particularly chromatic, but which are, however, temporary or semi-permanent on account of the nature of the bonds between the direct dyes and the keratin fiber. These interactions are weak and are such that desorption of the dyes from the surface and/or the core of the fiber takes place easily. The colorations generally show low dyeing power and poor fastness with respect to washing or perspiration. These direct dyes are also often light-sensitive since the resistance of the chromophore to photochemical attack is low, which leads to fading of the coloration of the hair over time. The sensitivity of these dyes to light depends on their uniform distribution or distribution as aggregates in and/or on the keratin fiber.

The present inventors have discovered, surprisingly and advantageously, novel compositions for dyeing keratin fibers, including human keratin fibers such as the hair, based on direct dyes of naphthoylene-benzimidazolium type, which allow the hair, even unsensitized hair, to be dyed strongly.

The compositions according to the present disclosure make it possible to obtain very strong, sparingly selective and fast shades. The colors obtained include bright yellow, orange, red or violet to blue-violet. Certain compositions even allow fluorescent dyes to be obtained.

In addition, these compositions may show good harmlessness.

Thus, the present disclosure relates to a dye composition for dyeing keratin fibers, including human keratin fibers such as the hair, of at least one naphthoylene-benzimidazolium direct dye of general formula (I) or corresponding mesomeric formulae.

The present disclosure further relates to a dye composition comprising at least one naphthoylene-benzimidazolium direct dye of formula (I) and at least one oxidation dye precursor and/or at least one conditioning agent and/or at least one thickening polymer and/or at least one surfactant.

Another aspect of the present disclosure relates to a process for dyeing keratin fibers, including human keratin fibers such as the hair, using this composition.

The present disclosure also relates to the use of the presently disclosed composition for obtaining on keratin fibers, including human keratin fibers such as the hair, very strong, sparingly selective and fast glints.

In one embodiment of the present disclosure, the dye composition is aqueous. The term “aqueous” means a composition containing at least 1% by weight of water, such as at least 10% water or at least 20% water.

Direct dyes of naphthoylene-benzimidazolium type that may be used in the compositions according to the present disclosure correspond to formula (I) below: 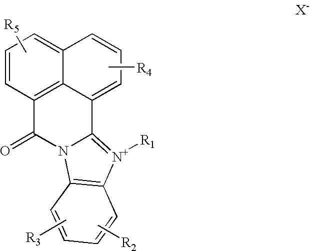
wherein:
   R₁ is chosen from a linear or branched C₁-C₁₀ alkyl group and an aryl(C₁-C₁₀)alkyl group;
   R₂ and R₃ are independently chosen from a hydrogen atom; linear and branched C₁-C₁₀ alkyl groups, linear and branched C₁-C₁₀ alkoxy groups, halogen atoms (e.g., F, Cl, Br or I), (C₁-C₁₀)alkoxycarbonyl groups, and CF₃ groups;
   R₄ and R₅ are independently chosen from a hydrogen atom; halogen atoms (e.g., F, Cl, Br or I); linear and branched C₁-C₁₀ alkyl groups; linear and branched C₁-C₁₀ alkoxy groups; hydroxyl groups; amino groups; linear and branched C₁-C₁₀ alkylamino groups; linear and branched C₁-C₁₀ dialkylamino groups; phenylamino groups; diphenylamino groups; (C₁-C₄)alkylaminophenylamino groups; aminophenylaminophenyl groups; linear and branched C₁-C₁₀ alkylthio groups; phenylthio group; (C₁-C₁₀)alkylphenylthio groups; (C₁-C₁₀)alkoxyphenylthio groups; phenyl(C₁-C₄)alkylthio groups; and morpholino groups; or R₄ and R₅ together form a 5- to 12-membered aromatic or heterocyclic ring; and
   X⁻ is chosen from a counterion of a mineral or organic acid.

These groups may optionally be substituted. The term “substituted” means substituted with at least one group chosen from hydroxyl, halogen (e.g., F, Cl, Br or I), C₁-C₁₀ alkoxy, amino, C₁-C₁₀ dialkylamino, C₁-C₁₀ mono- or dihydroxyalkylamino, amido(C₁-C₁₀)alkoxycarbonyl, C₂-C₁₀ acylamino, aryl and cyano groups.

Unless expressly described otherwise, the alkyl radicals or the alkyl portions of the groups containing alkyl radicals are of C₁-C₁₀ and may be linear or branched. Examples of alkyl radicals according to one embodiment of the present disclosure may include, for example, methyl, ethyl, n-propyl, isopropyl, butyl, etc. radicals. An alkoxy radical is a radical alk-O, the alkyl radical having the definition given above.

In one embodiment of the present disclosure, at least one of the substituents R₂, R₃, R₄ and R₅ denotes a hydrogen atom.

The direct dyes of formula (I) that may be used in the compositions according to the present disclosure may, for example, be chosen such that R₁ is chosen from a C₁-C₅ alkyl group; C₁-C₅ alkyl substituted with an OH radical; —CH₂—C₆H₄—CN; and —CH₂—C₆H₅.

In another embodiment of the present disclosure, R₂ and R₃ may independently be chosen from a hydrogen atom; Br; Cl; CF₃; C₁-C₄ alkyl groups; C₁-C₄ alkoxy groups; (C₁-C₆)alkoxycarbonyl groups; and C₁-C₈ hydroxyalkyl groups.

In yet another embodiment of the present disclosure, R₄ and R₅ may independently be chosen from a hydrogen atom, linear and branched C₁-C₄ alkyl groups, (C₁-C₄)alkylaminophenylamino groups, aminophenylaminophenyl groups, phenylthio groups, (C₁-C₁₀)alkylphenylthio groups, (C₁-C₁₀)alkoxyphenylthio groups, phenyl(C₁-C₄)alkylthio groups, and morpholino groups.

In a further embodiment, the direct dyes of formula (I) that may be used in the compositions according to the present disclosure are chosen from the following compounds, for which X⁻ may be chosen from a counterion of a mineral or organic acid such as, for example, Cl⁻, I⁻, CH₃—C₆H₄—SO₃⁻, and CH₃—O—SO₃⁻:

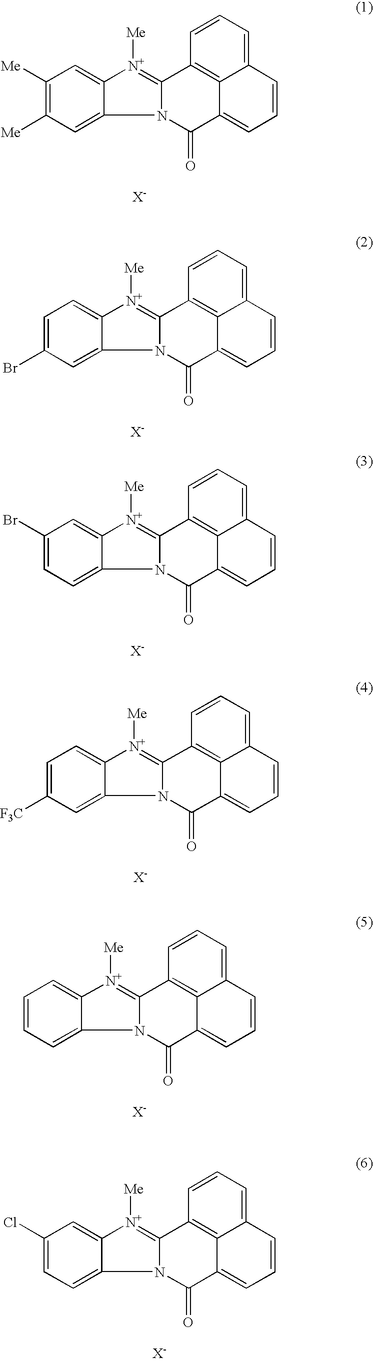

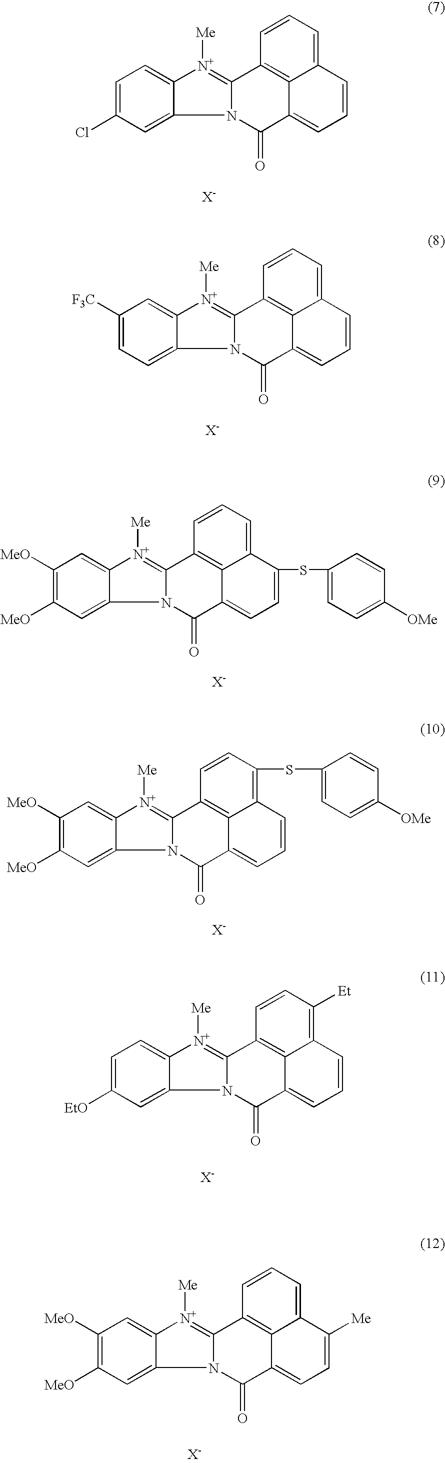

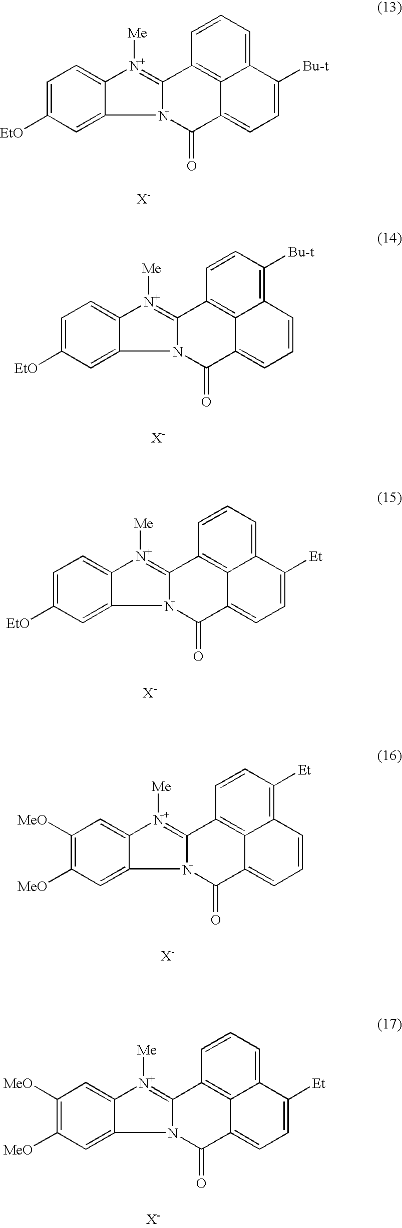

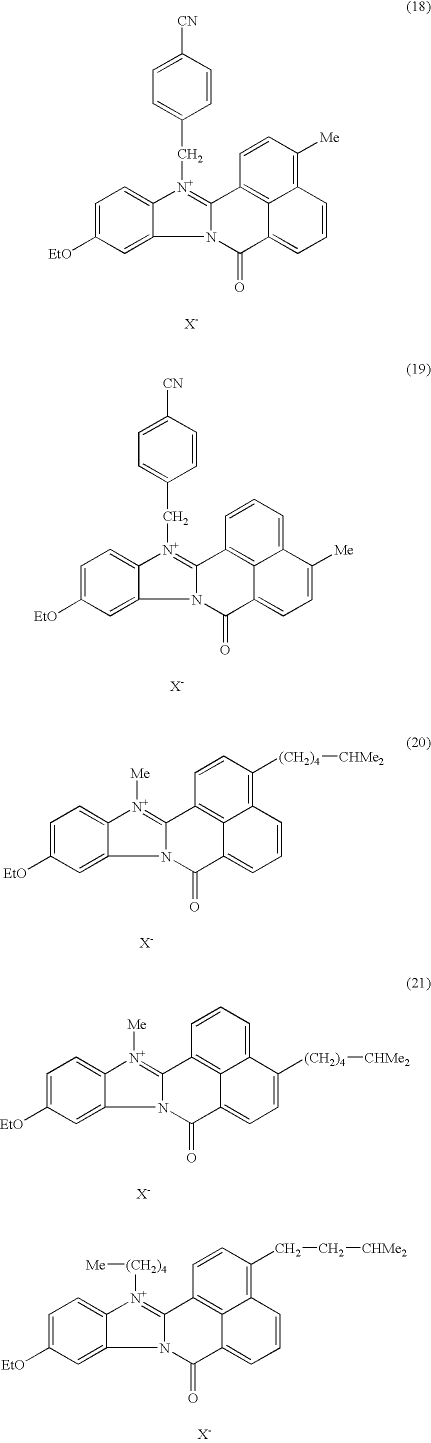

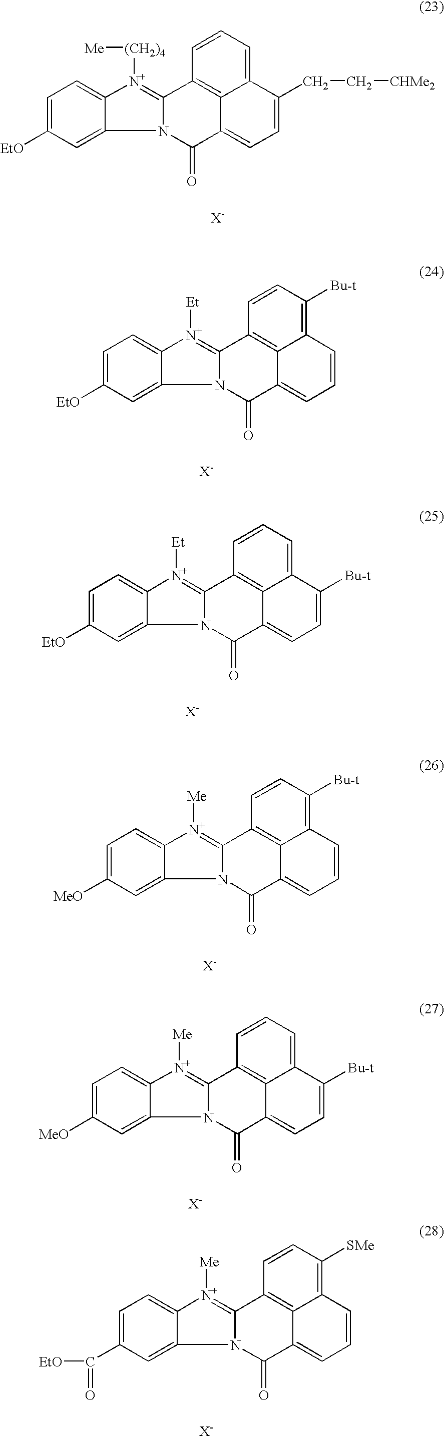

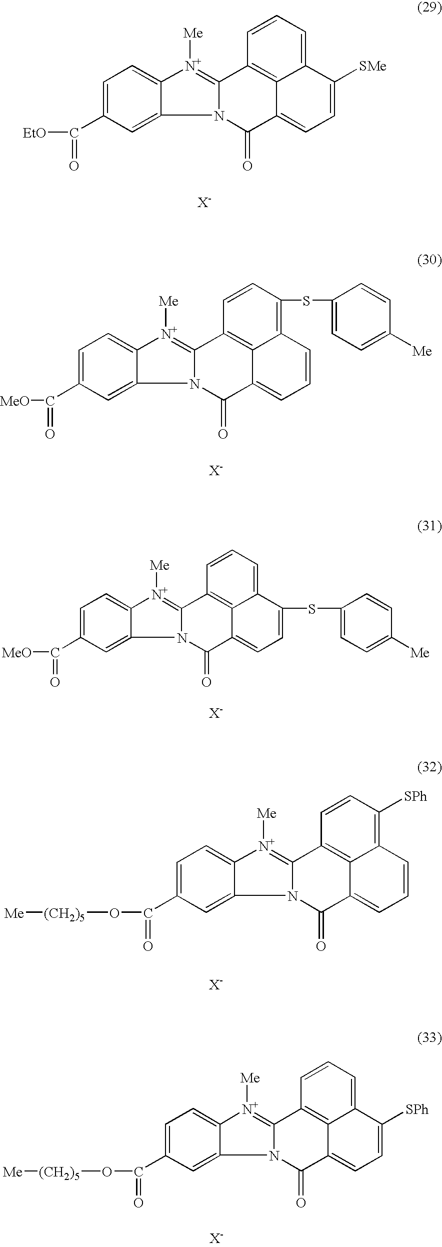

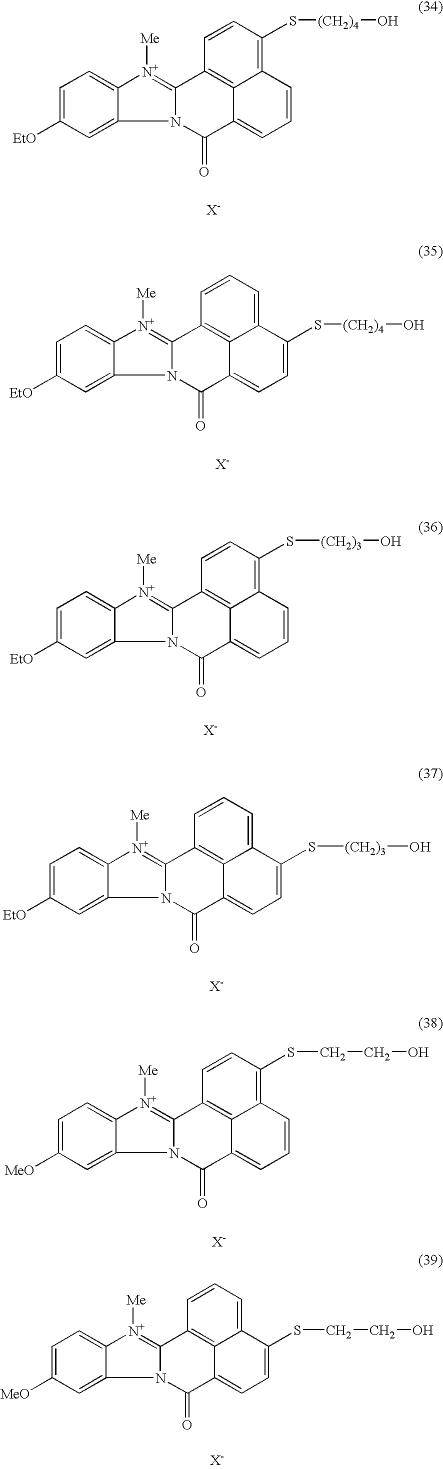

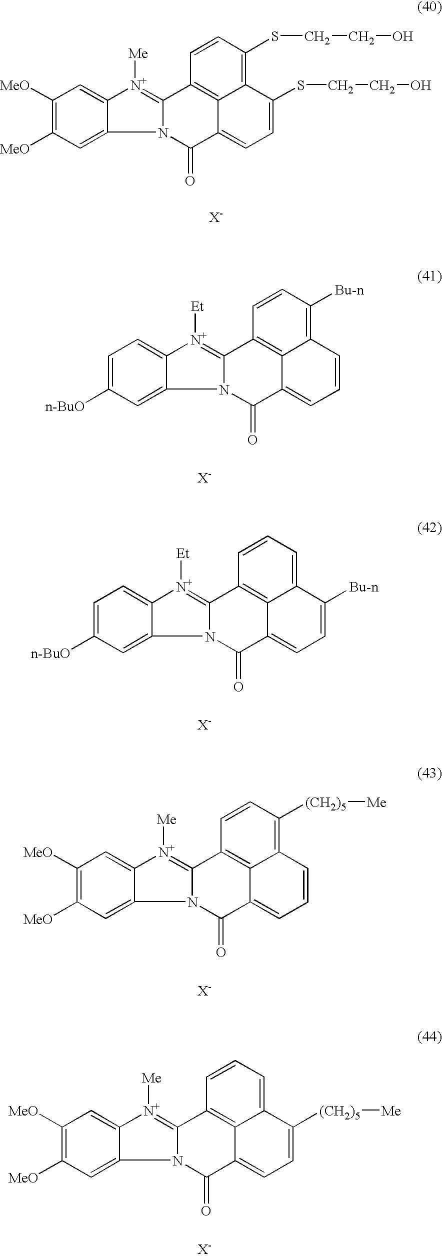

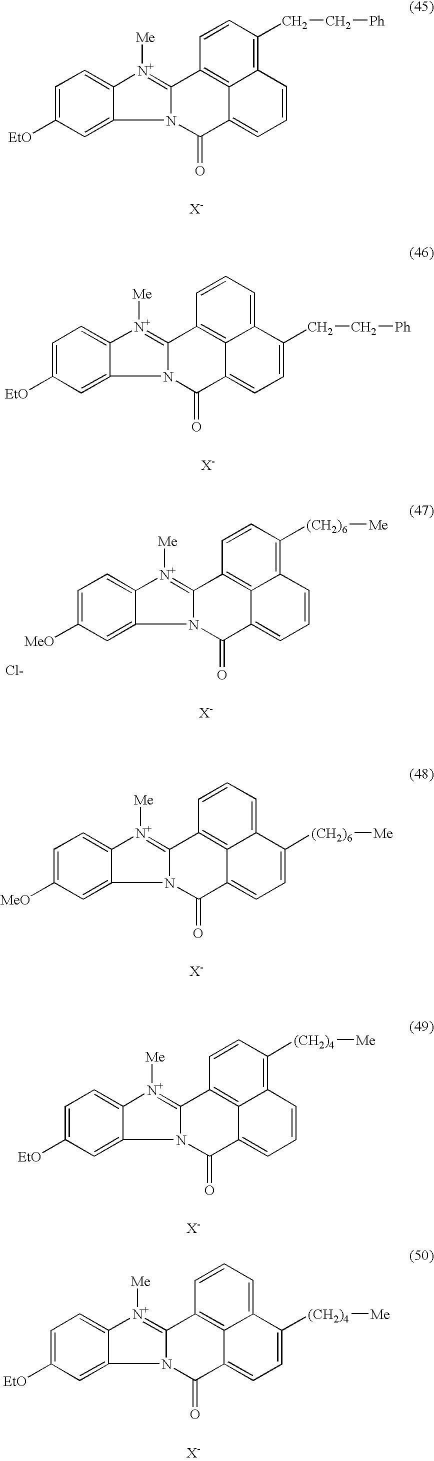

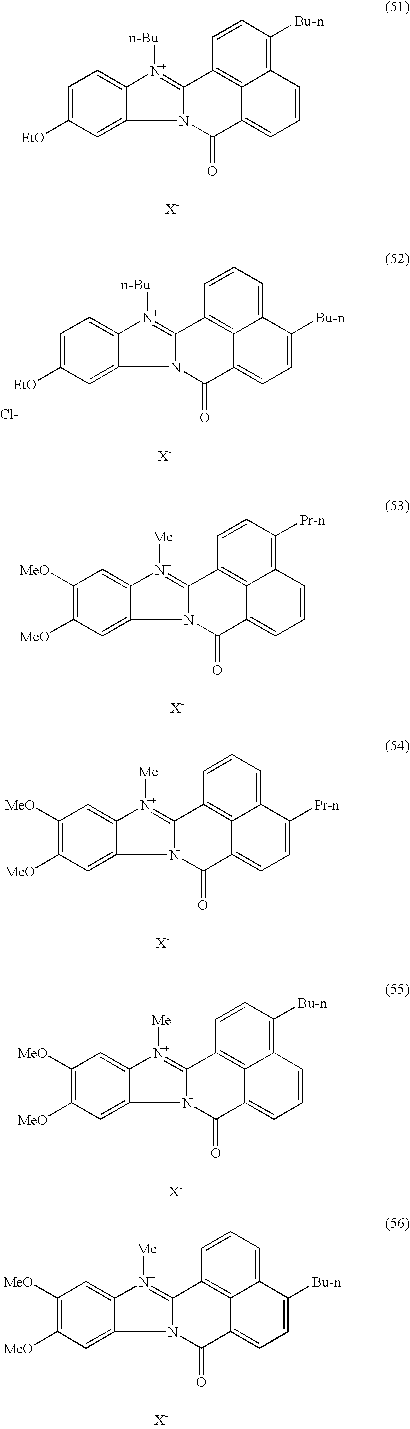

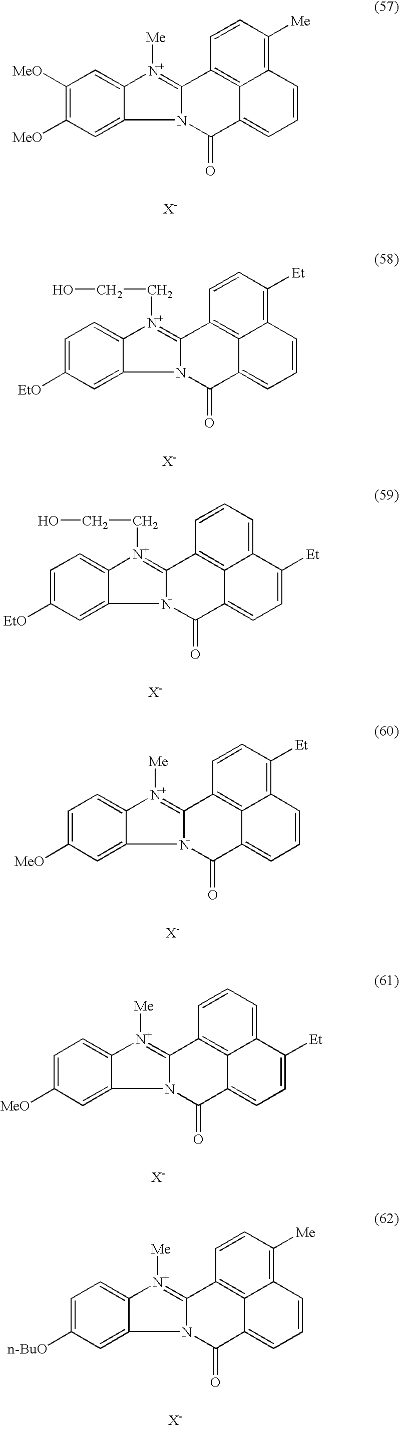

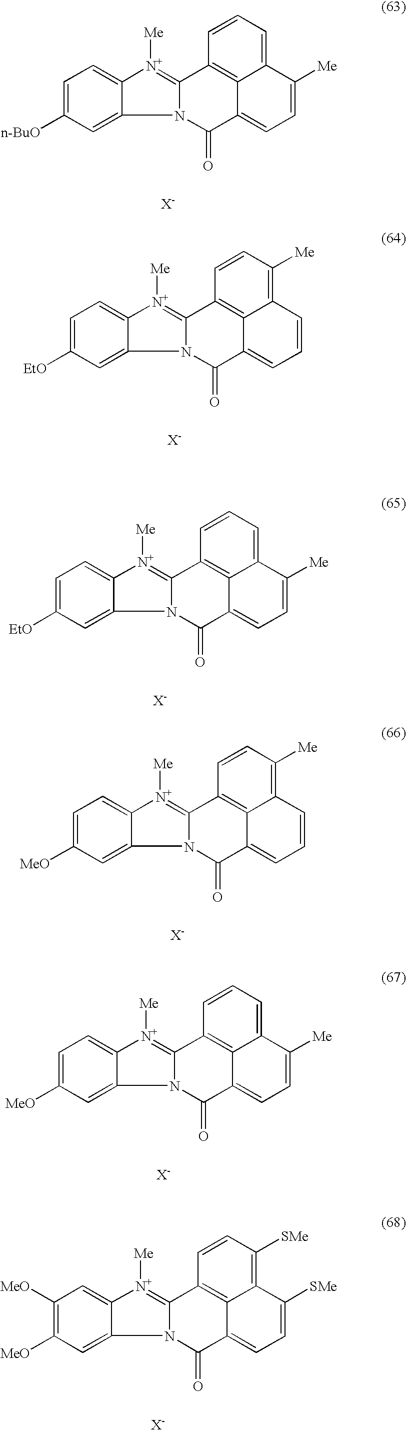

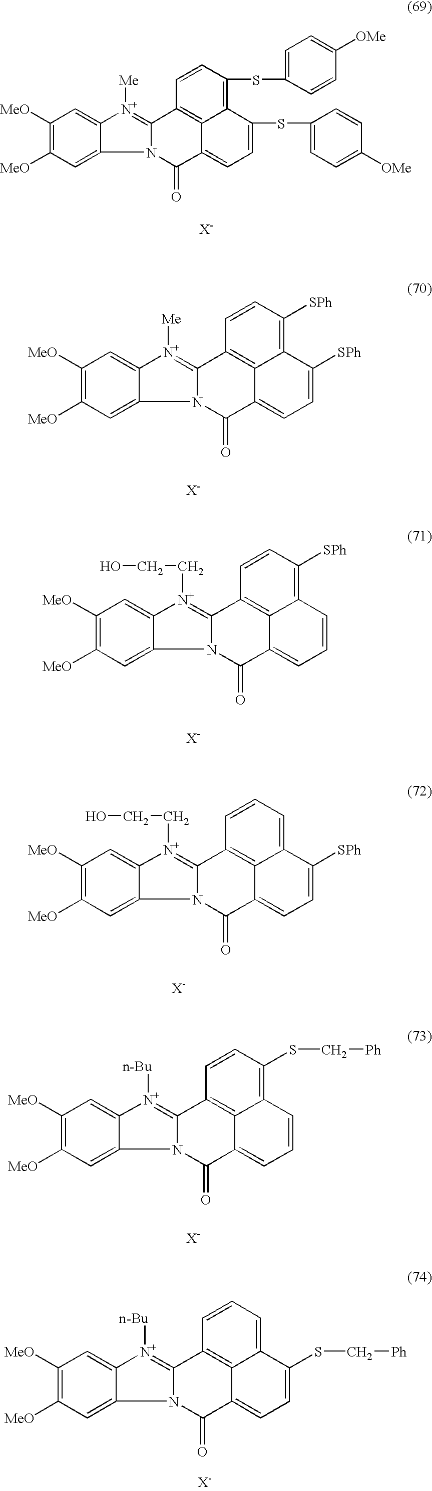

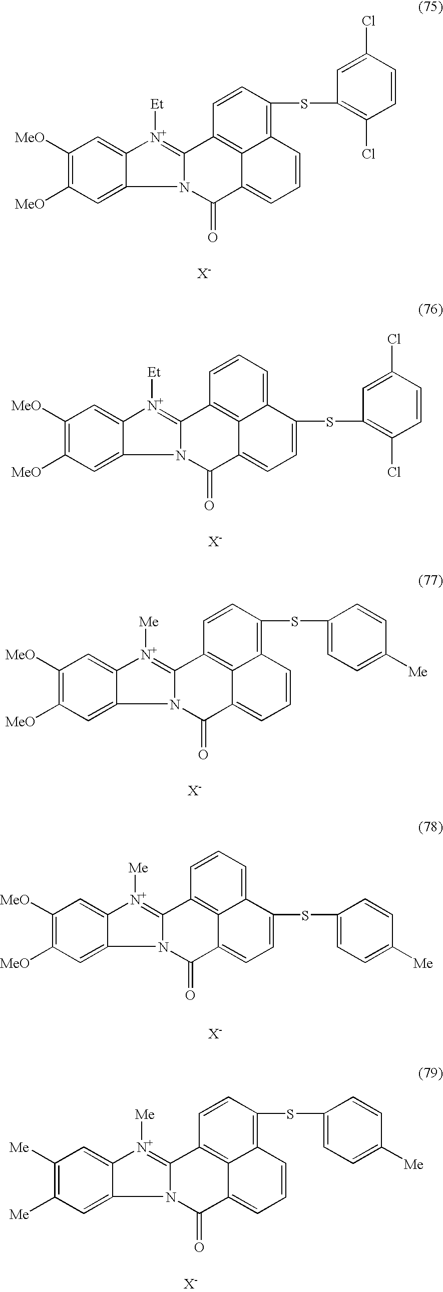

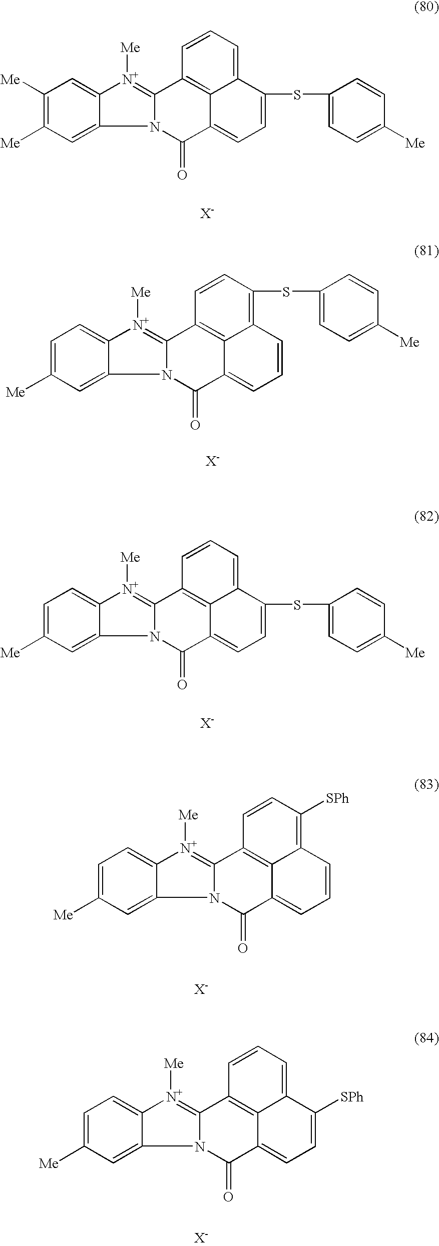

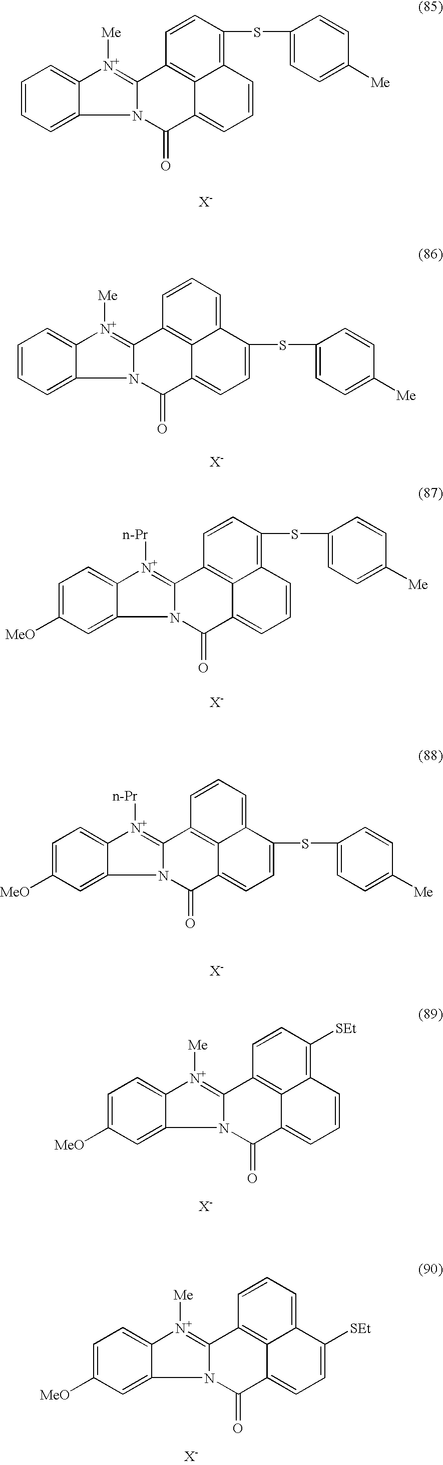

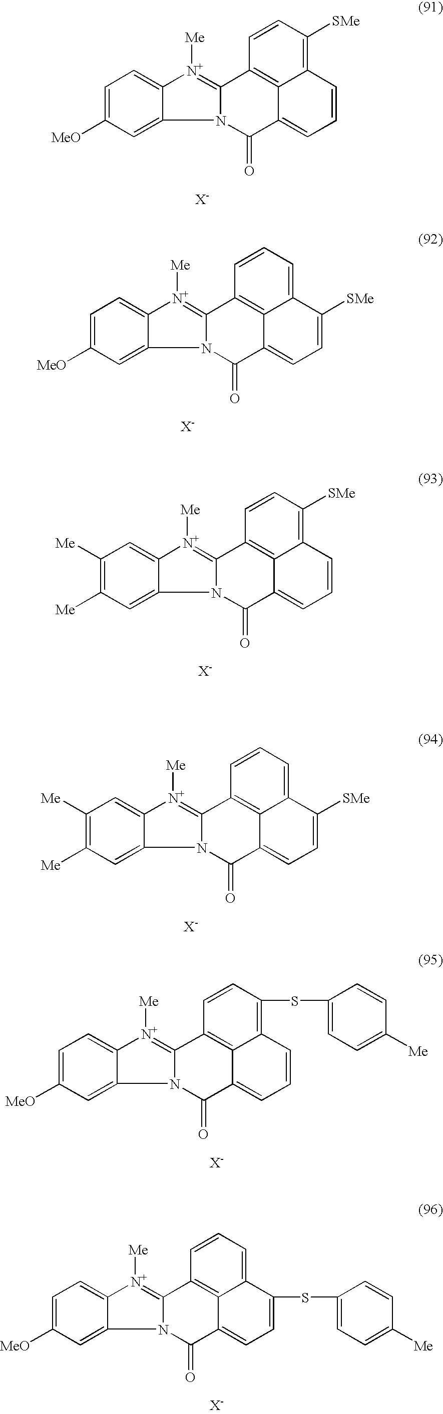

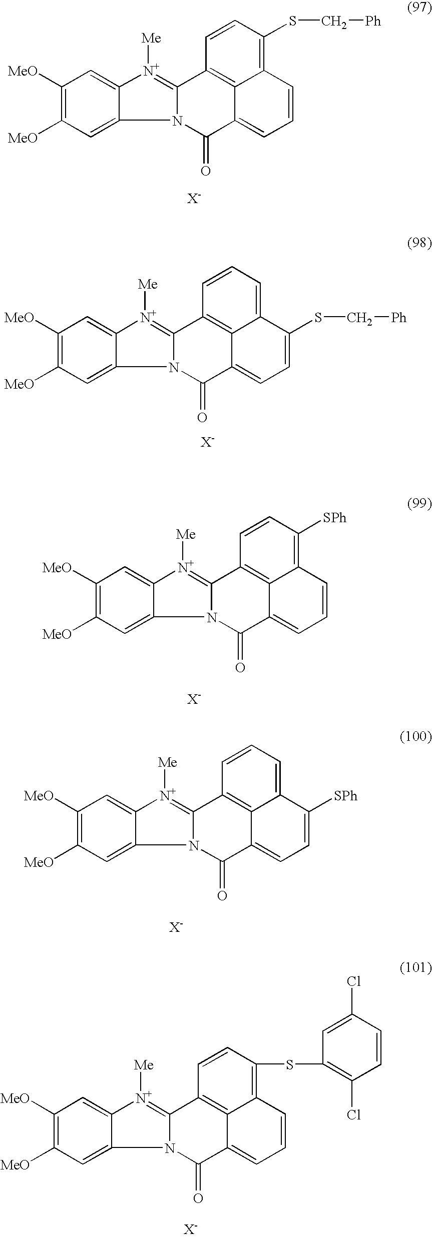

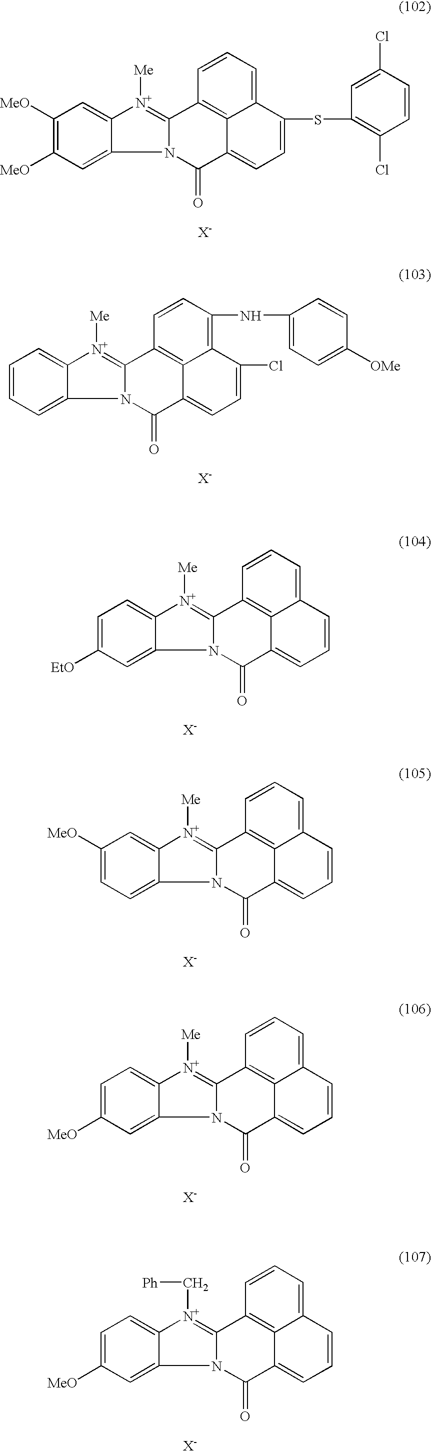

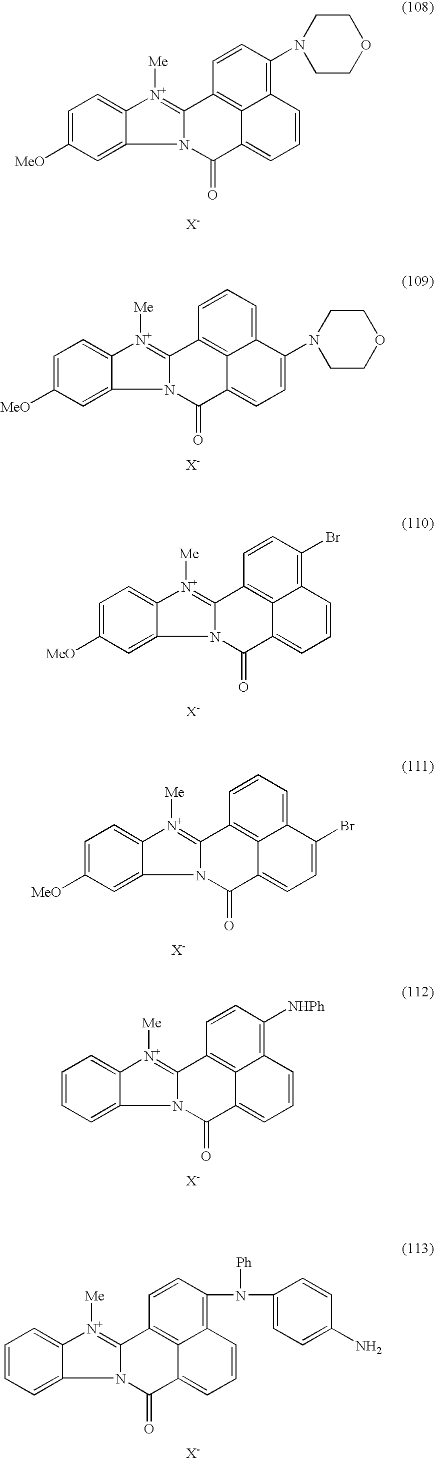

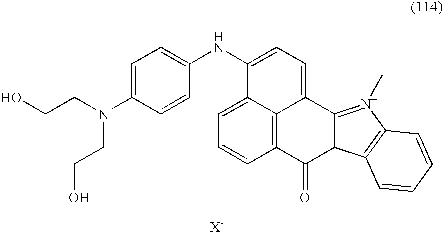

These compounds of formula (I) are known compounds. They may be prepared, for example, according to the methods described in published patent applications FR 2 052 153, CH 499 601, FR 1 472 179, DE 2 519 169 and FR 1 440 053.

The composition according to the present disclosure may comprise from 0.001% to 10%, such as from 0.01% to 10%, or 0.1% to 5% by weight of direct dye of formula (I) relative to the total weight of the composition.

According to one embodiment, the composition according to the present disclosure may also contain at least one conditioning agent, such as, for example, conditioning agents chosen from cationic polymers, cations, silicones, chitosans and chitosan derivatives.

In one embodiment, the concentration of the at least one conditioning agent in the composition according to the present disclosure may range from 0.01% to 10% by weight relative to the total weight of the composition. In other embodiments, the concentration of the at least one conditioning agent may range from 0.05% to 5% or from 0.1% to 3% by weight relative to the total weight of the composition.

According to another embodiment, the composition according to the present disclosure may also contain at least one thickening polymer, also known as a “rheology modifier.”

In one embodiment, the rheology modifiers may be chosen from fatty acid amides (e.g., coconut monoethanolamide or diethanolamide, oxyethylenated carboxylic acid alkyl ether monoethanolamide), cellulose-based thickeners (e.g., hydroxyethylcellulose, hydroxypropylcellulose or carboxymethylcellulose), guar gum and its derivatives (e.g., hydroxypropyl guar), gums of microbial origin (e.g., xanthan gum or scleroglucan gum), acrylic acid or acrylamidopropanesulfonic acid homopolymers and associative polymers such as water-soluble polymers that are capable, in an aqueous medium, of reversibly associating with each other or with other molecules.

The associative polymers that may be used according to the present disclosure may be of anionic, cationic, amphoteric, or nonionic type. In one embodiment, the composition may comprise a nonionic associative polymer.

In embodiments of the present disclosure comprising a thickening polymer, the weight concentration of thickening polymers in the dye composition may range from about 0.01% to 10%, such as from 0.1% to 5%, of the total weight of the composition.

According to yet another embodiment, the composition according to the present disclosure may contain at least one surfactant chosen from anionic, cationic, nonionic, amphoteric and zwitterionic surfactants.

The amounts of surfactants which may be present in the composition according to the present disclosure may range from 0.01% to 40% by weight relative to the total weight of the composition. In one embodiment, the surfactants may be present in an amount ranging from 0.1% to 30% by weight relative to the total weight of the composition.

The composition of the present disclosure may also comprise at least one oxidation dye precursor, such as, for example, at least one oxidation base and/or at least one coupler.

By way of example, the oxidation bases may be chosen from phenylenediamines, bis(phenyl)alkylenediamines, para-aminophenols, ortho-aminophenols and heterocyclic bases other than the heterocyclic para-phenylenediamines of formula (I), and the addition salts thereof.

Among the phenylenediamines that may be used according to the present disclosure, non-limiting mention may be made, for example, of para-phenylenediamine, para-tolylenediamine, 2-chloro-para-phenylenediamine, 2,3-dimethyl-para-phenylenediamine, 2,6-dimethyl-para-phenylenediamine, 2,6-diethyl-para-phenylenediamine, 2,5-dimethyl-para-phenylenediamine, N,N-dimethyl-para-phenylenediamine, N,N-diethyl-para-phenylenediamine, N,N-dipropyl-para-phenylenediamine, 4-amino-N,N-diethyl-3-methylaniline, N,N-bis(β-hydroxyethyl)-para-phenylenediamine, 4-N,N-bis(β-hydroxyethyl)amino-2-methylaniline, 4-N,N-bis(β-hydroxyethyl)amino-2-chloroaniline, 2-β-hydroxyethyl-para-phenylenediamine, 2-fluoro-para-phenylenediamine, 2-isopropyl-para-phenylenediamine, N-(β-hydroxypropyl)-para-phenylenediamine, 2-hydroxymethyl-para-phenylenediamine, N,N-dimethyl-3-methyl-para-phenylenediamine, N-ethyl-N-(β-hydroxyethyl)-para-phenylenediamine, N-(β,γ-dihydroxypropyl)-para-phenylenediamine, N-(4′-aminophenyl)-para-phenylenediamine, N-phenyl-para-phenylenediamine, 2-β-hydroxyethyloxy-para-phenylenediamine, 2-β-acetylaminoethyloxy-para-phenylenediamine, N-(β-methoxyethyl)-para-phenylenediamine, 4-aminophenylpyrrolidine, 2-thienyl-para-phenylenediamine, 2-β-hydroxyethylamino-5-aminotoluene, and 3-hydroxy-1-(4′-aminophenyl)pyrrolidine, and the addition salts thereof with an acid.

In a further embodiment of the present disclosure, para-phenylenediamines of the present disclosure may be chosen from para-phenylenediamine, para-tolylenediamine, 2-isopropyl-para-phenylenediamine, 2-β-hydroxyethyl-para-phenylenediamine, 2-β-hydroxyethyloxy-para-phenylenediamine, 2,6-dimethyl-para-phenylenediamine, 2,6-diethyl-para-phenylenediamine, 2,3-dimethyl-para-phenylenediamine, N,N-bis-(β-hydroxyethyl)-para-phenylenediamine, 2-chloro-para-phenylenediamine and 2-β-acetylaminoethyloxy-para-phenylenediamine, and the addition salts thereof with an acid.

Among the bis(phenyl)alkylenediamines that may be used according to the present disclosure, non-limiting mention may be made, for example, of N,N′-bis(β-hydroxyethyl)-N,N′-bis(4′-aminophenyl)-1,3-diaminopropanol, N,N′-bis(β-hydroxyethyl)-N,N′-bis(4′-aminophenyl)ethylenediamine, N,N′-bis(4-aminophenyl)tetramethylenediamine, N,N′-bis(β-hydroxyethyl)-N,N′-bis(4-aminophenyl)tetramethylenediamine, N,N′-bis(4-methylaminophenyl)tetramethylenediamine, N,N′-bis(ethyl)-N,N′-bis(4′-amino-3′-methylphenyl)ethylenediamine and 1,8-bis(2,5-diaminophenoxy)-3,6-dioxaoctane, and the addition salts thereof.

Among the para-aminophenols that may be used according to the present disclosure, non-limiting mention may be made, for example, of para-aminophenol, 4-amino-3-methylphenol, 4-amino-3-fluorophenol, 4-amino-3-chlorophenol, 4-amino-3-hydroxymethylphenol, 4-amino-2-methylphenol, 4-amino-2-hydroxymethylphenol, 4-amino-2-methoxymethylphenol, 4-amino-2-aminomethylphenol, 4-amino-2-(β-hydroxyethylamino-methyl)phenol and 4-amino-2-fluorophenol, and the addition salts thereof with an acid.

Among the ortho-aminophenols that may be used according to the present disclosure, non-limiting mention may be made, for example, of 2-aminophenol, 2-amino-5-methylphenol, 2-amino-6-methylphenol and 5-acetamido-2-aminophenol, and the addition salts thereof.

Among the heterocyclic bases that may be used according to the present disclosure, non-limiting mention may be made, for example, of pyridine derivatives, pyrimidine derivatives and pyrazole derivatives.

Among the pyridine derivatives that may be used according to the present disclosure, non-limiting mention may be made of the compounds described, for example, in patents GB 1 026 978 and GB 1 153 196, and 2,5-diaminopyridine, 2-(4-methoxyphenyl)amino-3-aminopyridine, and 3,4-diaminopyridine, and the addition salts thereof.

Other pyridine oxidation bases that may be used in a composition according to the present disclosure may include the 3-aminopyrazolo[1,5-a]pyridine oxidation bases or the addition salts thereof described, for example, in published patent application FR 2 801 308. Non-limiting examples that may be mentioned include pyrazolo[1,5-a]pyrid-3-ylamine, 2-acetylaminopyrazolo[1,5-a]pyrid-3-ylamine, 2-morpholin-4-ylpyrazolo[1,5-a]pyrid-3-ylamine, 3-aminopyrazolo[1,5-a]pyridine-2-carboxylic acid, 2-methoxypyrazolo[1,5-a]pyrid-3-ylamino, (3-aminopyrazolo[1,5-a]pyrid-7-yl)methanol, 2-(3-aminopyrazolo[1,5-a]pyrid-5-yl)ethanol, 2-(3-aminopyrazolo[1,5-a]pyrid-7-yl)ethanol, (3-aminopyrazolo[1,5-a]pyrid-2-yl)methanol, 3,6-diaminopyrazolo[1,5-a]pyridine, 3,4-diaminopyrazolo[1,5-a]pyridine, pyrazolo[1,5-a]pyridine-3,7-diamine, 7-morpholin-4-ylpyrazolo[1,5-a]pyrid-3-ylamine, pyrazolo[1,5-a]pyridine-3,5-diamine, 5-morpholin-4-ylpyrazolo[1,5-a]pyrid-3-ylamine, 2-[(3-aminopyrazolo[1,5-a]pyrid-5-yl)(2-hydroxyethyl)amino]ethanol, 2-[(3-aminopyrazolo[1,5-a]pyrid-7-yl)(2-hydroxyethyl)amino]ethanol, 3-aminopyrazolo[1,5-a]pyridin-5-ol, 3-aminopyrazolo[1,5-a]pyridin-4-ol, 3-aminopyrazolo[1,5-a]pyridin-6-ol and 3-aminopyrazolo[1,5-a]pyridin-7-ol, and the addition salts thereof.

Among the pyrimidine derivatives that may be used in a composition according to the present disclosure, non-limiting mention may be made of the compounds described, for example, in patents DE 2 359 399; JP 88-169 571; JP 05-163124; EP 0 770 375 or published patent application WO 96/15765, for instance 2,4,5,6-tetraminopyrimidine, 4-hydroxy-2,5,6-triaminopyrimidine, 2-hydroxy-4,5,6-triaminopyrimidine, 2,4-dihydroxy-5,6-diaminopyrimidine and 2,5,6-triaminopyrimidine, and the addition salts thereof, and the tautomeric forms thereof, when a tautomeric equilibrium exists.

Among the pyrazole derivatives that may be used according to the present disclosure, non-limiting mention may be made of the compounds described in patents DE 3 843 892 and DE 4 133 957, and published patent applications WO 94/08969, WO 94/08970, FR-A-2 733 749 and DE 195 43 988, for instance 4,5-diamino-1-methylpyrazole, 4,5-diamino-1-(β-hydroxyethyl)pyrazole, 3,4-diaminopyrazole, 4,5-diamino-1-(4′-chlorobenzyl)pyrazole, 4,5-diamino-1,3-dimethylpyrazole, 4,5-diamino-3-methyl-1-phenylpyrazole, 4,5-diamino-1-methyl-3-phenylpyrazole, 4-amino-1,3-dimethyl-5-hydrazinopyrazole, 1-benzyl-4,5-diamino-3-methylpyrazole, 4,5-diamino-3-tert-butyl-1-methylpyrazole, 4,5-diamino-1-tert-butyl-3-methylpyrazole, 4,5-diamino-1-(β-hydroxyethyl)-3-methylpyrazole, 4,5-diamino-1-ethyl-3-methylpyrazole, 4,5-diamino-1-ethyl-3-(4′-methoxyphenyl)pyrazole, 4,5-diamino-1-ethyl-3-hydroxymethylpyrazole, 4,5-diamino-3-hydroxymethyl-1-methylpyrazole, 4,5-diamino-3-hydroxymethyl-1-isopropylpyrazole, 4,5-diamino-3-methyl-1-isopropylpyrazole, 4-amino-5-(2′-aminoethyl)amino-1,3-dimethylpyrazole, 3,4,5-triaminopyrazole, 1-methyl-3,4,5-triaminopyrazole, 3,5-diamino-1-methyl-4-methylaminopyrazole and 3,5-diamino-4-(β-hydroxyethyl)amino-1-methylpyrazole, and the addition salts thereof. 4,5-Diamino-1-(β-methoxyethyl)pyrazole may also be mentioned.

When present, the at least one additional oxidation base may be present in the composition in an amount ranging from 0.001% to 20% by weight relative to the total weight of the dye composition, such as from 0.005% to 6% by weight relative to the total weight of the dye composition.

When at least one oxidation base is present, the composition according to the present disclosure may further contain at least one coupler conventionally used for dyeing keratin fibers. Among these couplers, non-limiting mention may be made of meta-phenylenediamines, meta-diphenols, naphthalene-based couplers and heterocyclic couplers, and also the addition salts thereof.

Non-limiting examples of couplers that may be mentioned include 1,3-dihydroxybenzene, 1,3-dihydroxy-2-methylbenzene, 4-chloro-1,3-dihydroxybenzene, 2,4-diamino-1-(β-hydroxyethyloxy)benzene, 2-amino-4-(β-hydroxyethylamino)-1-methoxybenzene, 1,3-diaminobenzene, 1,3-bis(2,4-diaminophenoxy)propane, 3-ureidoaniline, 3-ureido-1-dimethylaminobenzene, sesamol, 1-β-hydroxyethylamino-3,4-methylenedioxybenzene, α-naphthol, 2-methyl-1-naphthol, 6-hydroxyindole, 4-hydroxyindole, 4-hydroxy-N-methylindole, 2-amino-3-hydroxypyridine, 6-hydroxybenzomorpholine, 3,5-diamino-2,6-dimethoxypyridine, 1-N-(β-hydroxyethyl)amino-3,4-methylenedioxybenzene and 2,6-bis(β-hydroxyethylamino)toluene, and the addition salts thereof.

When present, the at least one coupler may generally be present in an amount ranging from 0.001% to 20% by weight, such as from 0.005% to 6% by weight, relative to the total weight of the dye composition.

In general, the addition salts of the oxidation bases and couplers that may be used in the composition of the present disclosure may be chosen from addition salts with an acid, such as, for example, the hydrochlorides, hydrobromides, sulfates, citrates, succinates, tartrates, lactates, tosylates, benzenesulfonates, phosphates and acetates, and addition salts with a base, such as, for example, sodium hydroxide, potassium hydroxide, ammonia, amines or alkanolamines.

In one embodiment, the dye composition in accordance with the present disclosure may also contain at least one additional direct dye other than the direct dyes of naphthoylene-benzimidazolium type of formula (I), which may be chosen from neutral, acidic or cationic nitrobenzene dyes, neutral, acidic or cationic azo direct dyes, neutral, acidic or cationic quinone, such asanthraquinone, direct dyes, azine direct dyes, triarylmethane direct dyes, indoamine direct dyes and natural direct dyes.

Among the benzene-based direct dyes that may be used according to the present disclosure, mention may be made, in a non-limiting manner, of the following compounds:
1,4-diamino-2-nitrobenzene;
1-amino-2-nitro-4-(β-hydroxyethylamino)benzene;
1-amino-2-nitro-4-bis(β-hydroxyethyl)aminobenzene;
1,4-bis(β-hydroxyethylamino)-2-nitrobenzene;
1-β-hydroxyethylamino-2-nitro-4-bis(β-hydroxyethylamino)benzene;
1-β-hydroxyethylamino-2-nitro-4-aminobenzene;
1-β-hydroxyethylamino-2-nitro-4-(ethyl)(β-hydroxyethyl)aminobenzene;
1-amino-3-methyl-4-β-hydroxyethylamino-6-nitrobenzene;
1-amino-2-nitro-4-β-hydroxyethylamino-5-chlorobenzene;
1,2-diamino-4-nitrobenzene;
1-amino-2-β-hydroxyethylamino-5-nitrobenzene;
1,2-bis(β-hydroxyethylamino)-4-nitrobenzene;
1-amino-2-[tris(hydroxymethyl)methylamino]-5-nitrobenzene;
1-hydroxy-2-amino-5-nitrobenzene;
1-hydroxy-2-amino-4-nitrobenzene;
1-hydroxy-3-nitro-4-aminobenzene;
1-hydroxy-2-amino-4,6-dinitrobenzene;
1-β-hydroxyethyloxy-2-β-hydroxyethylamino-5-nitrobenzene;
1-methoxy-2-β-hydroxyethylamino-5-nitrobenzene;
1-β-hydroxyethyloxy-3-methylamino-4-nitrobenzene;
1-β,γ-dihydroxypropyloxy-3-methylamino-4-nitrobenzene;
1-β-hydroxyethylamino-4-β,γ-dihydroxypropyloxy-2-nitrobenzene;
1-β,γ-dihydroxypropylamino-4-trifluoromethyl-2-nitrobenzene;
1-β-hydroxyethylamino-4-trifluoromethyl-2-nitrobenzene;
1-β-hydroxyethylamino-3-methyl-2-nitrobenzene;
1-β-aminoethylamino-5-methoxy-2-nitrobenzene;
1-hydroxy-2-chloro-6-ethylamino-4-nitrobenzene;
1-hydroxy-2-chloro-6-amino-4-nitrobenzene;
1-hydroxy-6-[bis(β-hydroxyethyl)amino]-3-nitrobenzene;
1-β-hydroxyethylamino-2-nitrobenzene; and
1-hydroxy-4-β-hydroxyethylamino-3-nitrobenzene.

Among the azo direct dyes that may be used according to the invention, non-limiting mention may be made of the cationic azo dyes described in published patent applications WO 95/15144, WO 95/01772 and EP 714 954, the contents of which are incorporated herein by reference.

Among these compounds, non-limiting mention may be made the following dyes:
1,3-dimethyl-2-[[4-(dimethylamino)phenyl]azo]-1H-imidazolium chloride;
1,3-dimethyl-2-[(4-aminophenyl)azo]-1H-imidazolium chloride; and
1-methyl-4-[(methylphenylhydrazono)methyl]pyridinium methyl sulfate.

Among the azo direct dyes that may also be used according to the present disclosure, non-limiting mention may be made of the following dyes described in the Color Index International 3rd edition:

Disperse Red 17;

Acid Yellow 9;

Acid Black 1;

Basic Red 22;

Basic Red 76;

Basic Yellow 57;

Basic Brown 16;

Acid Yellow 36;

Acid Orange 7;

Acid Red 33;

Acid Red 35;

Basic Brown 17;

Acid Yellow 23;

Acid Orange 24; and

Disperse Black 9.

Non-limiting mention may also be made of 1-(4′-aminodiphenylazo)-2-methyl-4-[bis(β-hydroxyethyl)amino]benzene and 4-hydroxy-3-(2-methoxyphenylazo)-1-naphthalenesulfonic acid.

Among the quinone direct dyes that may be used according to the present disclosure, non-limiting mention can be made of the following dyes:

Disperse Red 15;

Solvent Violet 13;

Acid Violet 43;

Disperse Violet 1;

Disperse Violet 4;

Disperse Blue 1;

Disperse Violet 8;

Disperse Blue 3;

Disperse Red 11;

Acid Blue 62;

Disperse Blue 7;

Basic Blue 22;

Disperse Violet 15;

Basic Blue 99;

and also the following compounds:
1-N-methylmorpholiniumpropylamino-4-hydroxyanthraquinone;
1-aminopropylamino-4-methylaminoanthraquinone;
1-aminopropylaminoanthraquinone;
5-β-hydroxyethyl-1,4-diaminoanthraquinone;
2-aminoethylaminoanthraquinone; and
1,4-bis(β,γ-dihydroxypropylamino)anthraquinone.

Among the azine dyes that may be used according to the present disclosure, non-limiting mention can be made of the following compounds:

Basic Blue 17; and

Basic Red 2.

Among the triarylmethane dyes that may be used according to the disclosure, non-limiting mention may be made of the following compounds:

Basic Green 1;

Acid Blue 9.

Basic Violet 3.

Basic Violet 14.

Basic Blue 7.

Acid Violet 49.

Basic Blue 26. and

Acid Blue 7.

Among the indoamine dyes that may be used according to the disclosure, non-limiting mention may be made of the following compounds:
2-β-hydroxyethylamino-5-[bis(β-4′-hydroxyethyl)amino]anilino-1,4-benzoquinone;
2-β-hydroxyethylamino-5-(2′-methoxy-4′-amino)anilino-1,4-benzoquinone;
3-N(2′-chloro-4′-hydroxy)phenylacetylamino-6-methoxy-1,4-benzoquinoneimine;
3-N(3′-chloro-4′-methylamino)phenylureido-6-methyl-1,4-benzoquinoneimine; and
3-[4′-N-(ethylcarbamylmethyl)amino]phenylureido-6-methyl-1,4-benzoquinoneimine.

Among the natural direct dyes that may be used according to the disclosure, non-limiting mention may be made of lawsone, juglone, alizarin, purpurin, carminic acid, kermesic acid, purpurogallin, protocatechaldehyde, indigo, isatin, curcumin, spinulosin, and apigenidin. Extracts or decoctions containing these natural dyes may also be used, such as, for example, henna-based poultices or extracts.

When present, the at least one additional direct dye may be present in the composition in an amount ranging from 0.001% to 20% by weight, such as from 0.005% to 10% by weight, relative to the total weight of the ready-to-use composition.

The composition according to the present disclosure may also contain at least one hydroxylated solvent, such as, for example, ethanol, propylene glycol, glycerol, polyol monoethers or benzyl alcohol.

The presently disclosed composition may also contain a non-hydroxylated solvent.

The hydroxylated solvents and the non-hydroxylated solvents, when present, may be present in an amount ranging from 1% to 40% by weight, such as from 5% to 30% by weight, relative to the total weight of the dye composition.

The presently disclosed dye composition may also contain various adjuvants conventionally used in compositions for dyeing the hair, such as, for example, antioxidants, penetrating agents, sequestering agents, fragrances, buffers, dispersants, pH regulators, film-forming agents, ceramides, preserving agents and opacifiers.

When present, the above adjuvants may be present in an amount for each ranging from 0.01% to 20% by weight relative to the weight of the composition.

Needless to say, a person skilled in the art will take care to select any of these optional additional compounds such that the beneficial properties intrinsically associated with the oxidation dye composition in accordance with the present disclosure are not, or are not substantially, adversely affected by the envisaged addition.

The pH of the dye composition disclosed herein may range from 3 to 12, such as from 5 to 11 or from 6 to 8.5. The pH may be adjusted to the desired value by means of acidifying or basifying pH regulators usually used for dyeing keratin fibers, or alternatively using standard buffer systems.

Among the acidifying agents that may be used according to the present disclosure, non-limiting mention may be made, for example, of mineral or organic acids other than dicarboxylic acids, such as hydrochloric acid, orthophosphoric acid, sulfuric acid, carboxylic acids, for instance acetic acid, tartaric acid, citric acid or lactic acid, and sulfonic acids.

Among the basifying agents that may be used according to the present disclosure, non-limiting mention may be made, for example, of aqueous ammonia, alkaline carbonates, alkanolamines such as monoethanolamine, diethanolamine and triethanolamine and derivatives thereof, sodium hydroxide, potassium hydroxide and the compounds of formula (XXIII) below: 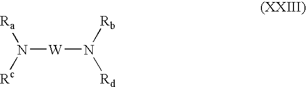
wherein W is a propylene residue optionally substituted with a hydroxyl group or a C₁-C₄ alkyl radical; Rₐ, R_{b}, R_{c} and R_{d}, which may be identical or different, are chosen from a hydrogen atom, C₁-C₄ alkyl groups, and C₁-C₄ hydroxyalkyl radicals.

The dye composition according to the present disclosure may be in various forms, such as, for example, in the form of liquids, creams or gels, or in any other form that is suitable for dyeing keratin fibers, including human hair.

The process according to the present disclosure includes applying the dye composition according to the present disclosure to the keratin fibers, and then in leaving it to act for a period sufficient to allow the coloration of the hair. In one embodiment, this period may range from 5 minutes to 1 hour, such as from 15 minutes to 1 hour.

In another embodiment, the process for dyeing keratin fibers, including when the composition according to the disclosure comprises at least one oxidation dye precursor, may include a step using an oxidizing agent. The oxidizing agent may be added to the composition of the disclosure just at the time of use, or it may be used starting with an oxidizing composition containing it, which is applied simultaneously with or sequentially to the composition of the disclosure.

According to one embodiment, the composition according to the present disclosure comprising at least one oxidation dye precursor is mixed, such as at the time of use, with a composition containing, in a medium that is suitable for dyeing, at least one oxidizing agent, wherein the oxidizing agent is present in an amount sufficient to develop a coloration. The mixture obtained can then be applied to the keratin fibers. After a leave-in time ranging from 5 minutes to 1 hour, such as, for example from 15 minutes to 1 hour, the keratin fibers can be rinsed, washed with shampoo, rinsed again and then dried.

The oxidizing agents conventionally used for the oxidation dyeing of keratin fibers may be used herein, such as, for example, hydrogen peroxide, urea peroxide, alkali metal bromates, persalts such as perborates and persulfates, peracids and oxidase enzymes, among which non-limiting mention may be made of peroxidases, two-electron oxidoreductases such as uricases, and four-electron oxygenases, for instance laccases. In one embodiment, the oxidizing agent may be hydrogen peroxide.

The oxidizing composition may also contain various adjuvants conventionally used in hair dye compositions and as defined above.

The pH of the oxidizing composition containing the oxidizing agent is such that, after mixing with the dye composition, the pH of the resulting composition applied to the keratin fibers ranges from 3 to 12, such as from 5 to 11 or from 6 to 8.5. The pH may be adjusted to the desired value by means of acidifying or basifying pH regulators usually used in the dyeing of keratin fibers and as defined above.

The ready-to-use composition comprising at least one oxidation dye precursor that is finally applied to the keratin fibers may be in various forms, such as, for example, in the form of liquids, creams or gels, or in any other form that is suitable for dyeing keratin fibers, including human hair.

Also disclosed herein is a multi-compartment device or dyeing kit, in which a first compartment contains the dye composition defined above and a second compartment contains an oxidizing composition. This device may be equipped with a means for applying the desired mixture to the hair, such as the devices described in patent FR 2 586 913.

Using this device, it is possible to dye the keratin fibers by means of a process that includes the mixing of a dye composition in accordance with the present disclosure with an oxidizing agent as defined above, and the application of the mixture obtained to the keratin fibers for a time that is sufficient to develop a desired coloration.

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should be construed in light of the number of significant digits and ordinary rounding approaches.

Notwithstanding the numerical ranges and parameters setting forth the broad scope of the invention are approximations, the numerical values set forth in the specific examples are reported as precisely as possible. Any numerical value, however, inherently contains certain errors necessarily resulting from the standard deviation found in its respective testing measurement.

The example that follows illustrates the invention without, however, being limiting in nature.

### EXAMPLE OF A DYE COMPOSITION ACCORDING TO THE INVENTION

| Compound | Amount | |
|---|---|---|
| 13-Methyl-7-oxo-7H-benzimidazo[2,1-a]benz[de]- | 0.2 | g |
| isoquinolinium iodide corresponding to dye (5) | | |
| Polyquaternium-6 | 0.05 | g |
| Dodecyl polyglucoside | 4 | g AM |
| Hydroxyethylcellulose | 0.5 | g |
| Ethanol | 10 | g |

| | |
|---|---|
| 2-Amino-2-methyl-1-propanol | qs pH = 9 |
| Demineralized water | qs 100 g |

What is claimed is:

1. A dye composition for dyeing keratin fibers, comprising, in a suitable dyeing medium, at least one direct dye of formula (I): 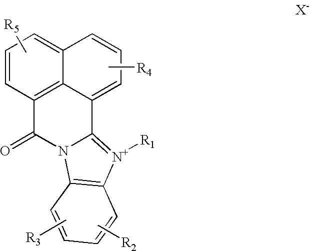
wherein:
R₁ is chosen from a linear or branched C₁-C₁₀ alkyl group and a linear or branched aryl(C₁-C₁₀)alkyl group;
R₂ and R₃ are independently chosen from a hydrogen atom, linear or branched C₁-C₁₀ alkyl groups, linear or branched C₁-C₁₀ alkoxy groups, halogen atoms, (C₁-C₁₀)alkoxycarbonyl groups, and CF₃;
R₄ and R₅ are independently chosen from a hydrogen atom, halogen atoms, linear or branched C₁-C₁₀ alkyl groups, linear or branched C₁-C₁₀ alkoxy groups, hydroxyl groups, amino groups, linear or branched C₁-C₁₀ alkylamino groups, linear or branched C₁-C₁₀ dialkylamino groups, phenylamino groups, diphenylamino groups, (C₁-C₄)alkylaminophenylamino groups, aminophenylaminophenyl groups, linear or branched C₁-C₁₀ alkylthio groups, phenylthio groups, (C₁-C₁₀)alkylphenylthio groups, (C₁-C₁₀)alkoxyphenylthio groups, phenyl(C₁-C₄)alkylthio groups, and morpholino groups, or R₄ and R₅ together form a 5- to 12-membered aromatic or heterocyclic ring; and
X⁻ is a counterion of a mineral acid or an organic acid.

2. A dye composition according to claim 1, wherein R₁ is chosen from a C₁-C₄ alkyl group; a C₁-C₅ alkyl group substituted with an OH radical; —CH₂—C₆H₄—CN;
and —CH₂—C₆H₅.

3. A dye composition according to claim 1, wherein R₂ and R₃ are independently chosen from a hydrogen atom; Br; Cl; CF₃; C₁-C₄ alkyl groups; C₁-C₄ alkoxy groups; (C₁-C₆)alkoxycarbonyl groups; and C₁-C₈ hydroxyalkyl groups.

4. A dye composition according to claim 1, wherein R₄ and R₅ are independently chosen from a hydrogen atom, linear or branched C₁-C₄ alkyl groups; (C₁-C₄)alkylaminophenylamino groups; aminophenylaminophenyl groups; phenylthio groups; (C₁-C₁₀)alkylphenylthio groups; (C₁-C₁₀)alkoxyphenylthio groups; phenyl(C₁-C₄)alkylthio groups; and morpholino groups.

5. A dye composition according to claim 1, wherein said at least one direct dye of formula (I) is chosen from the following compounds, wherein X⁻ is a counterion of a mineral acid or an organic acid:

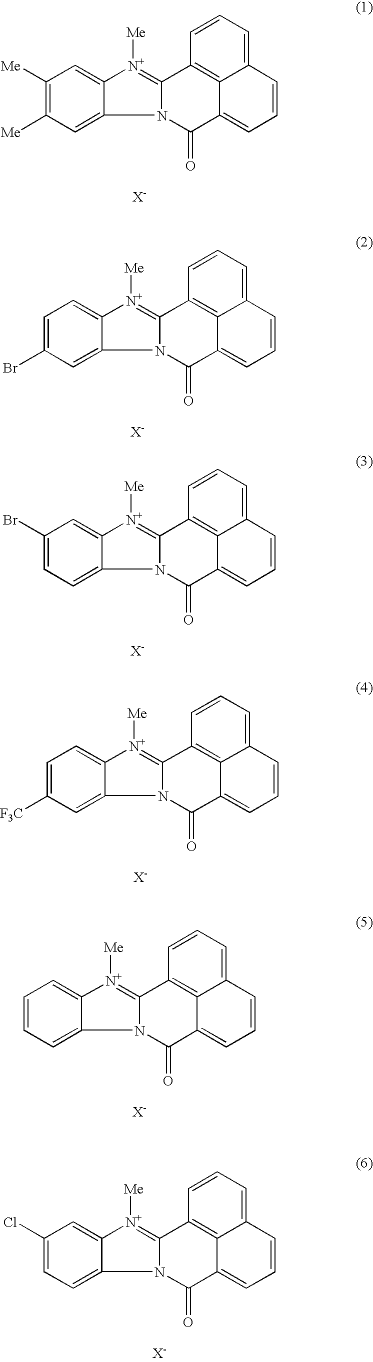

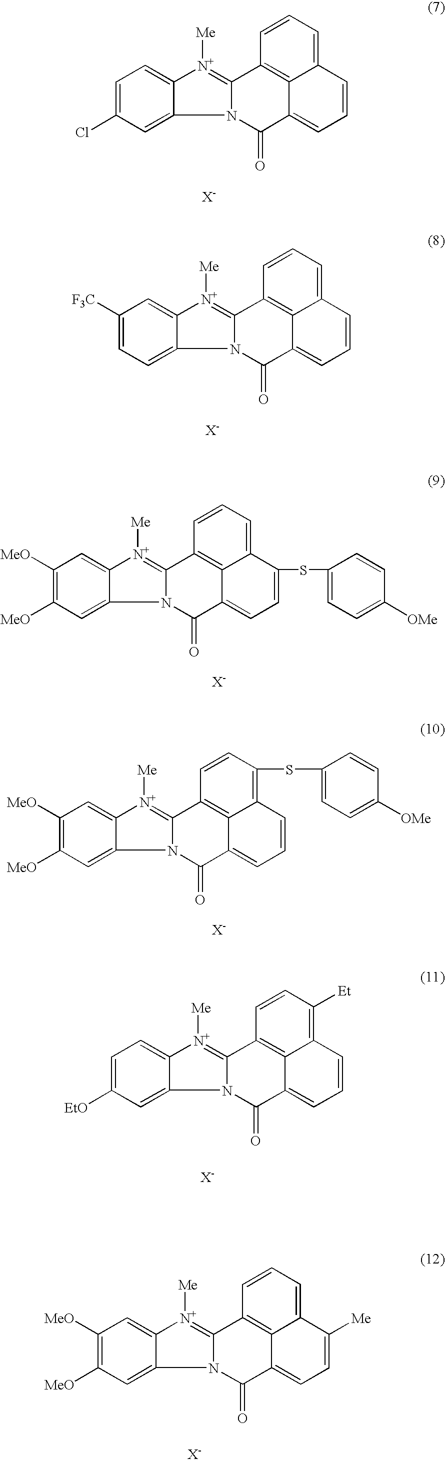

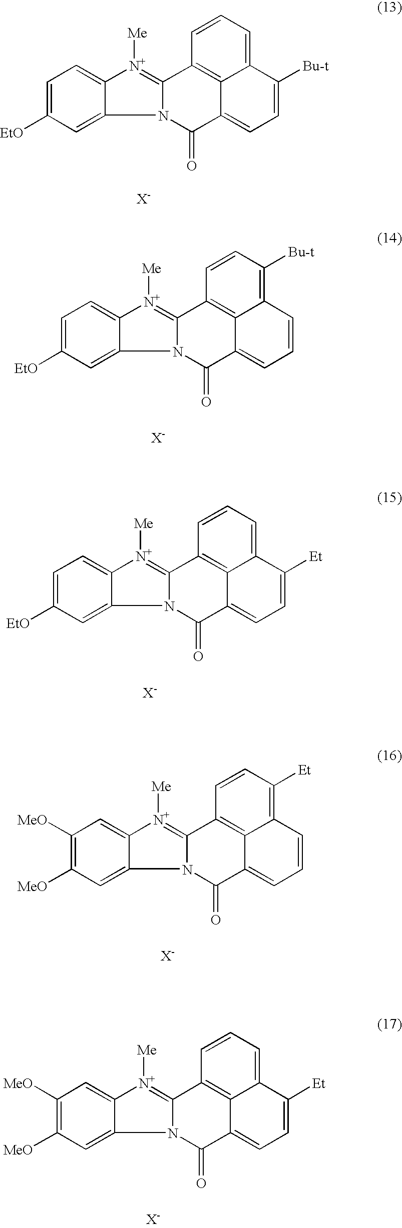

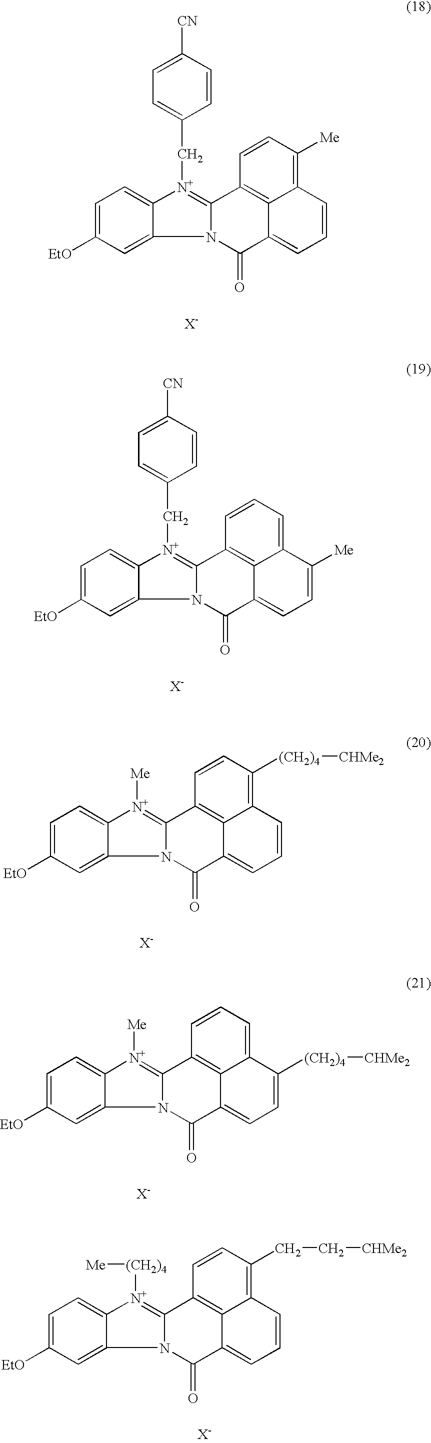

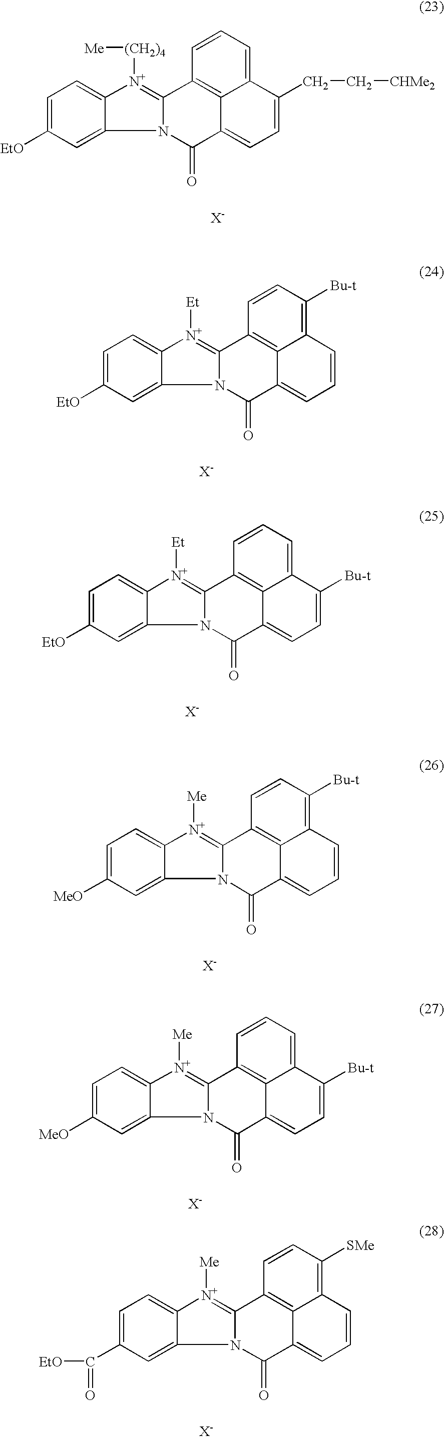

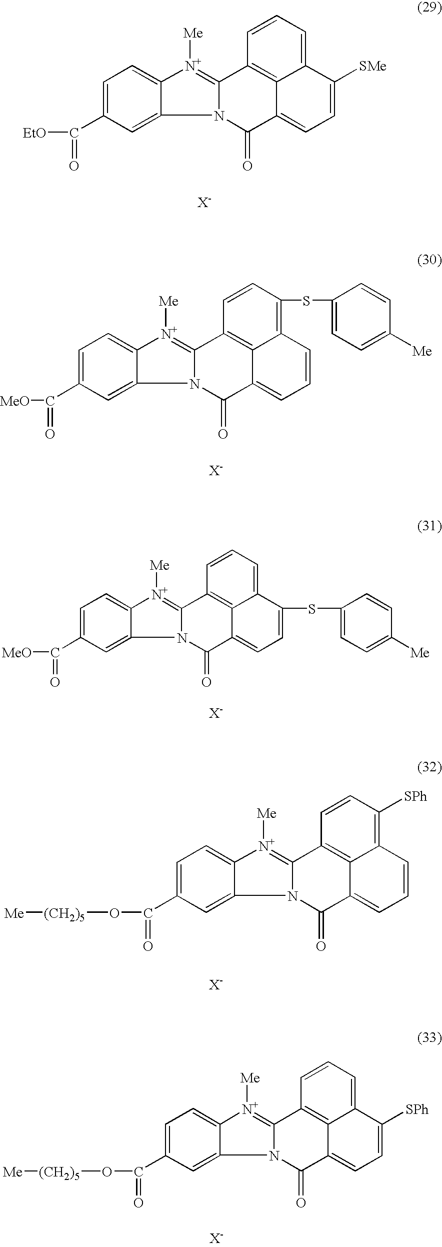

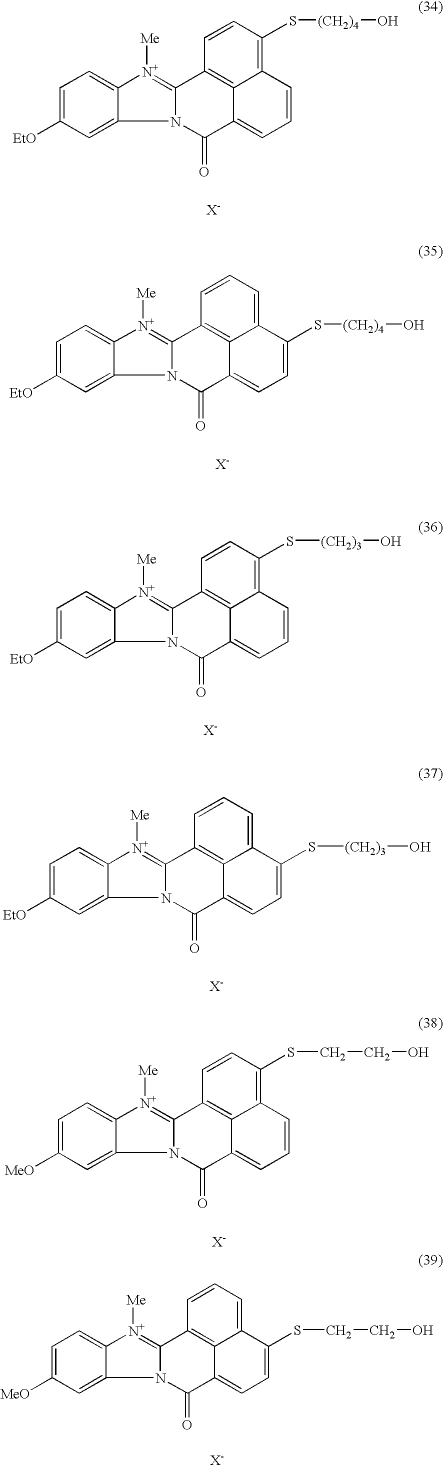

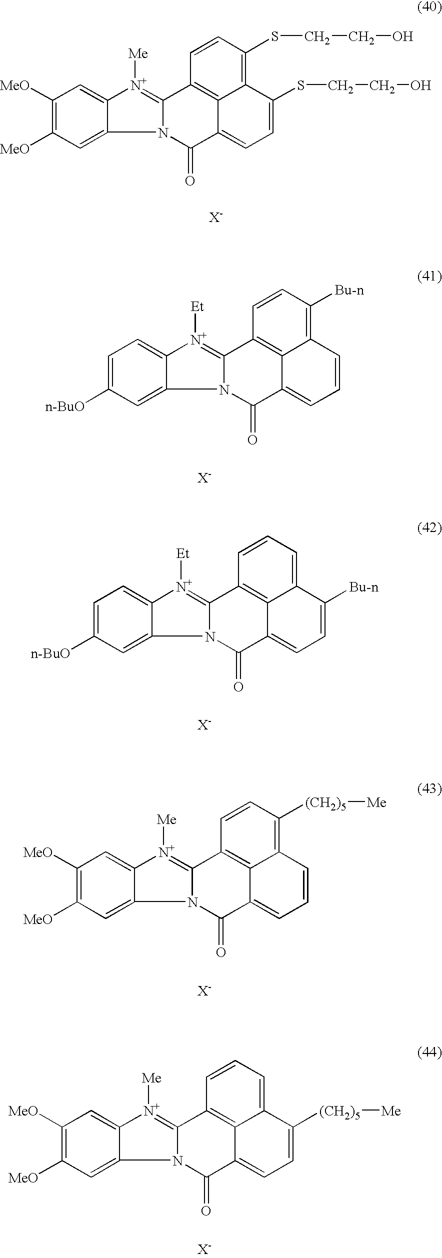

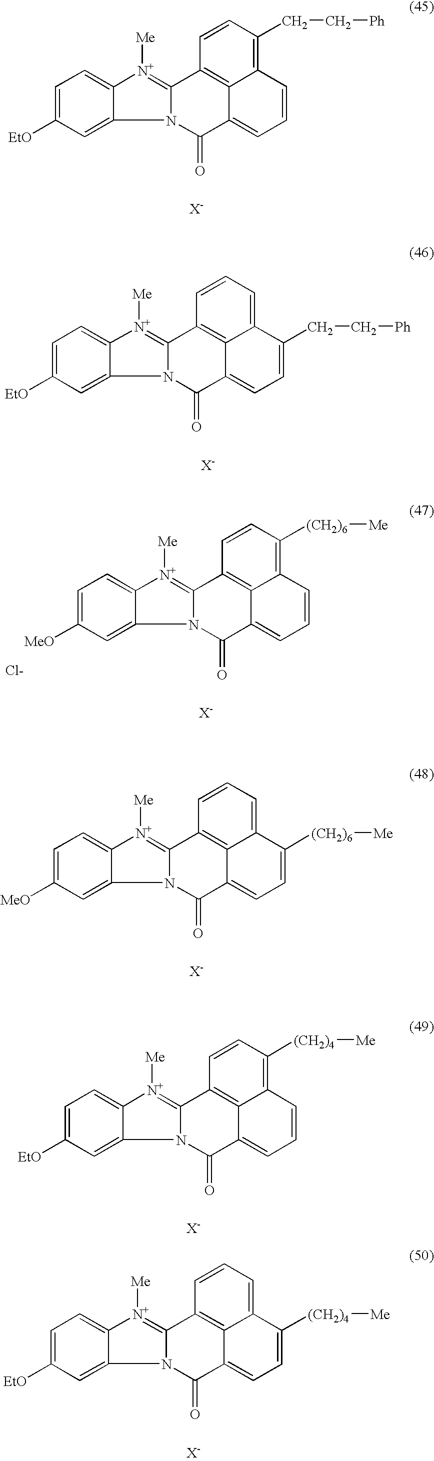

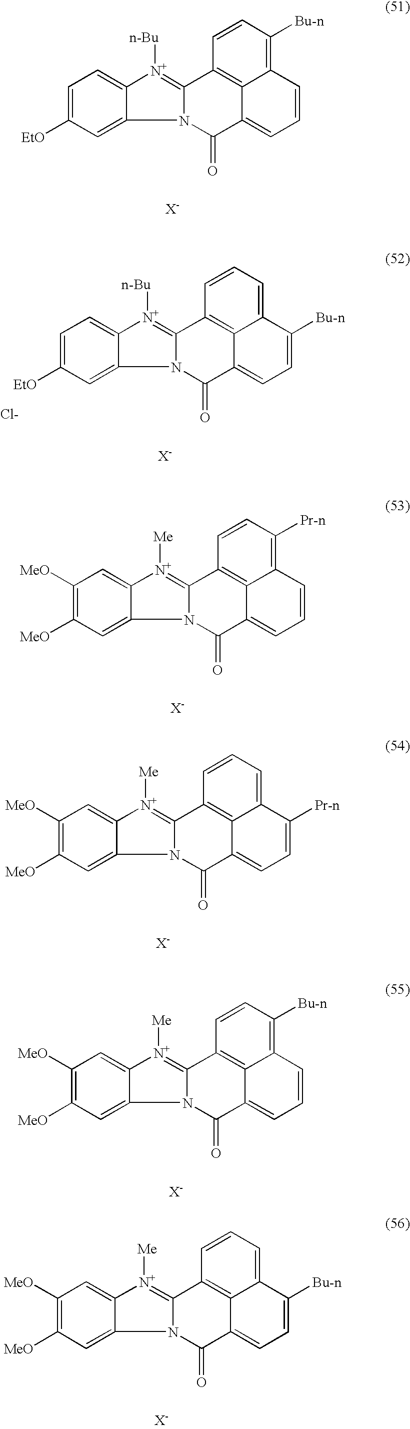

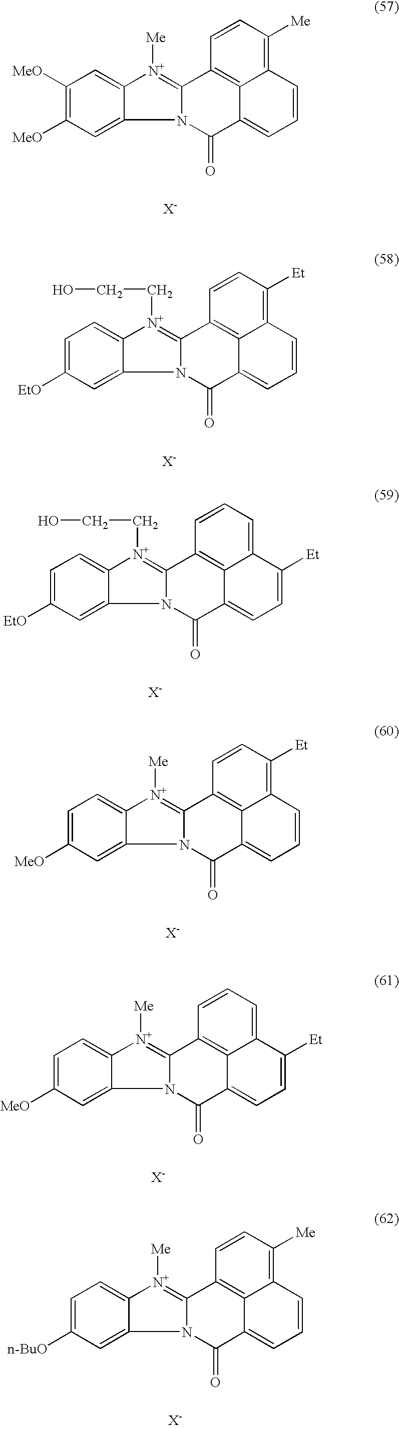

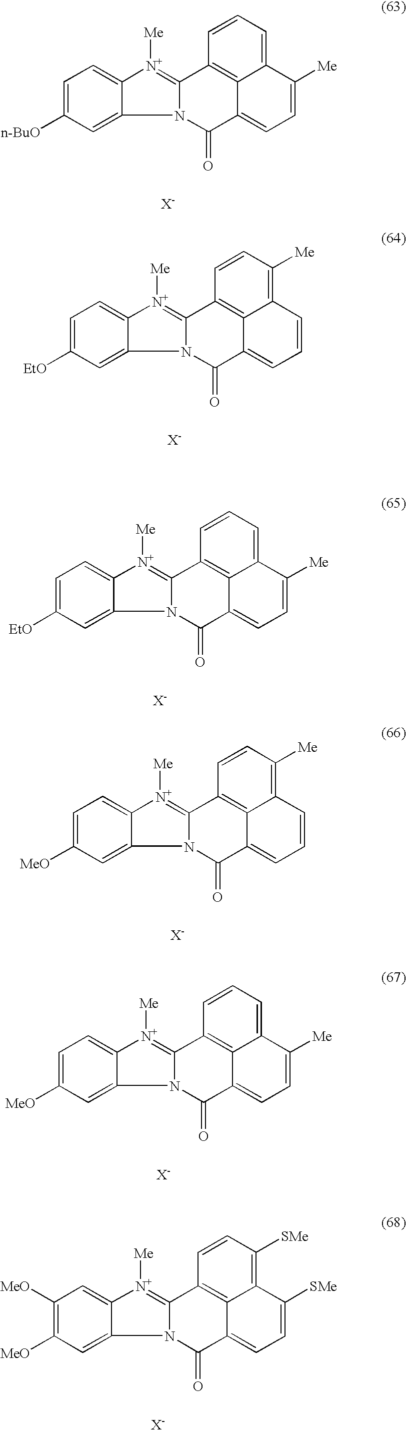

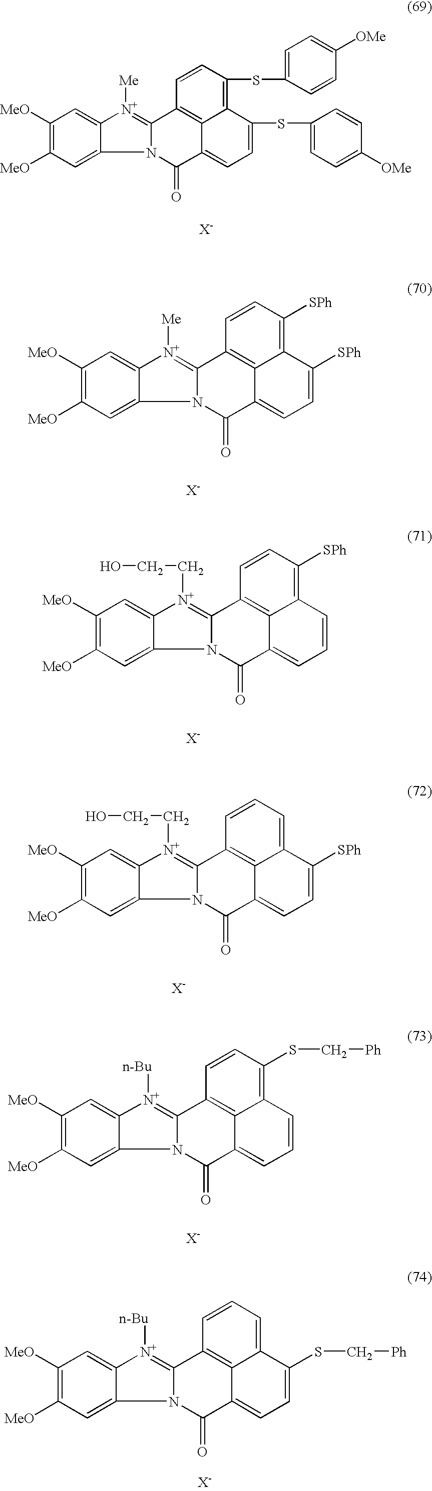

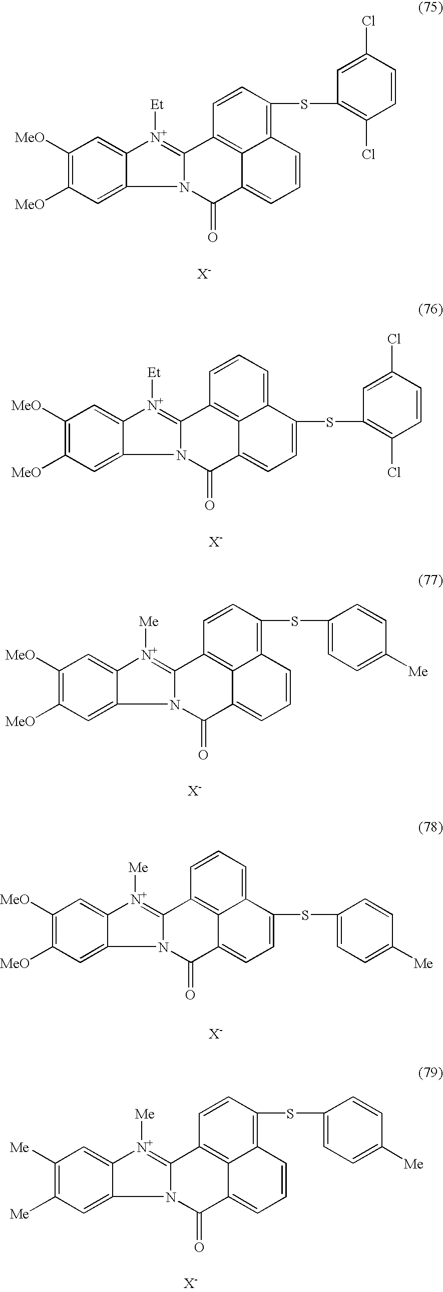

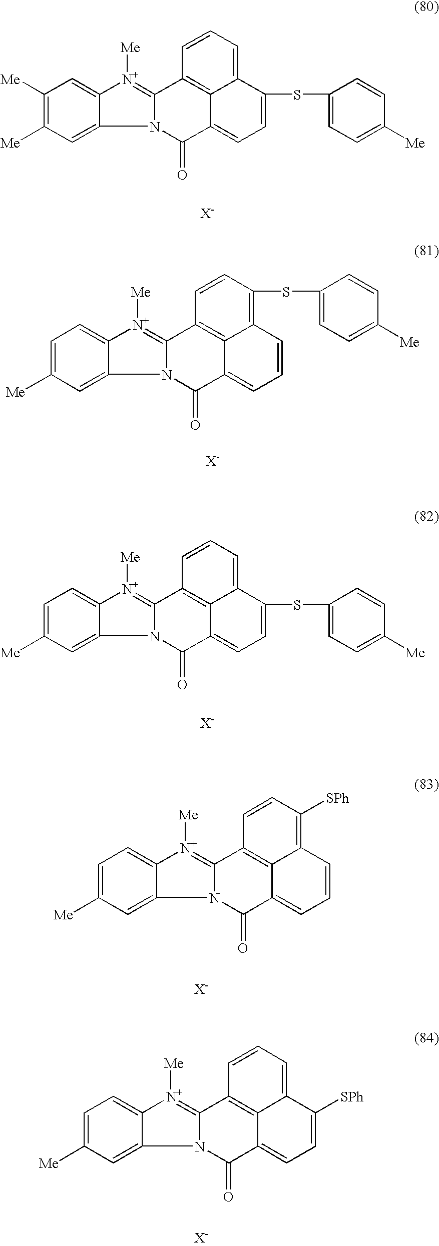

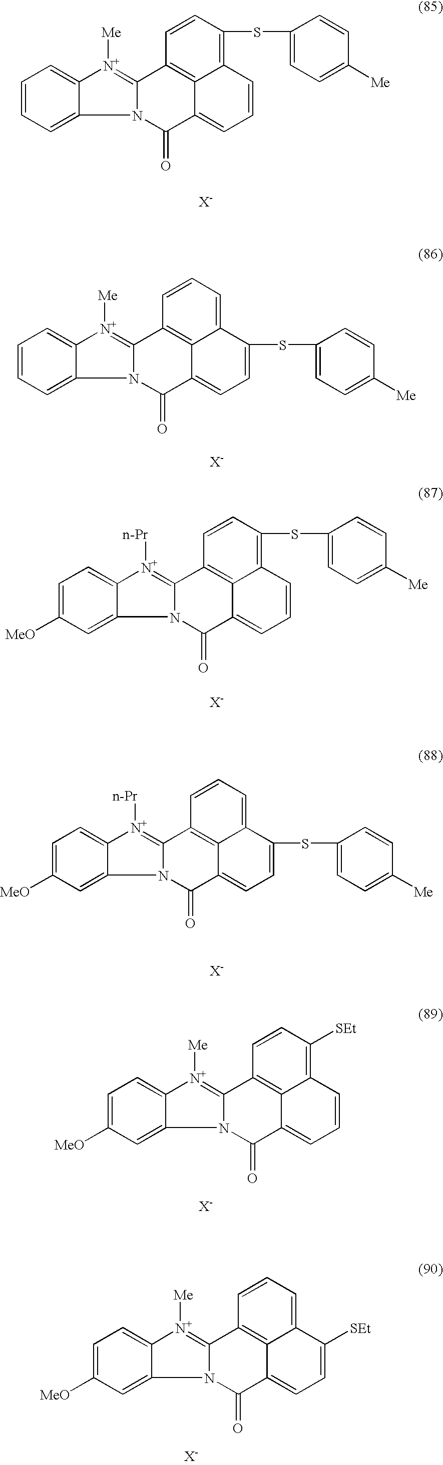

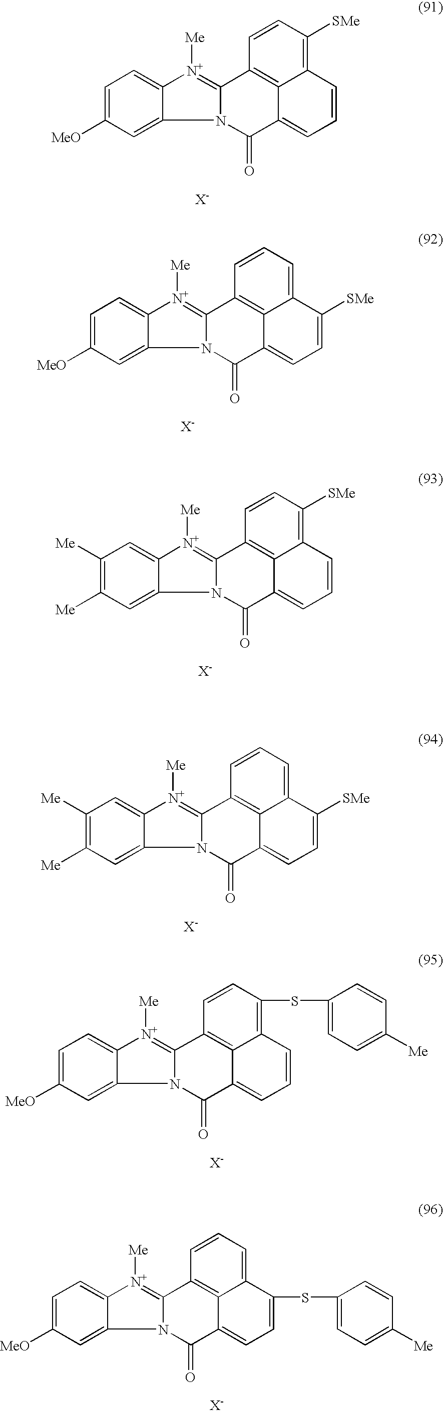

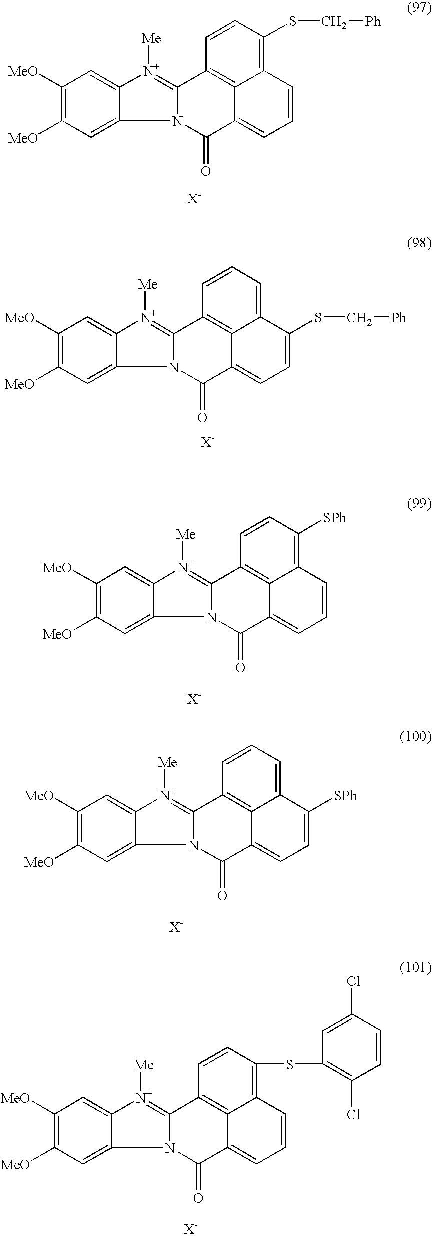

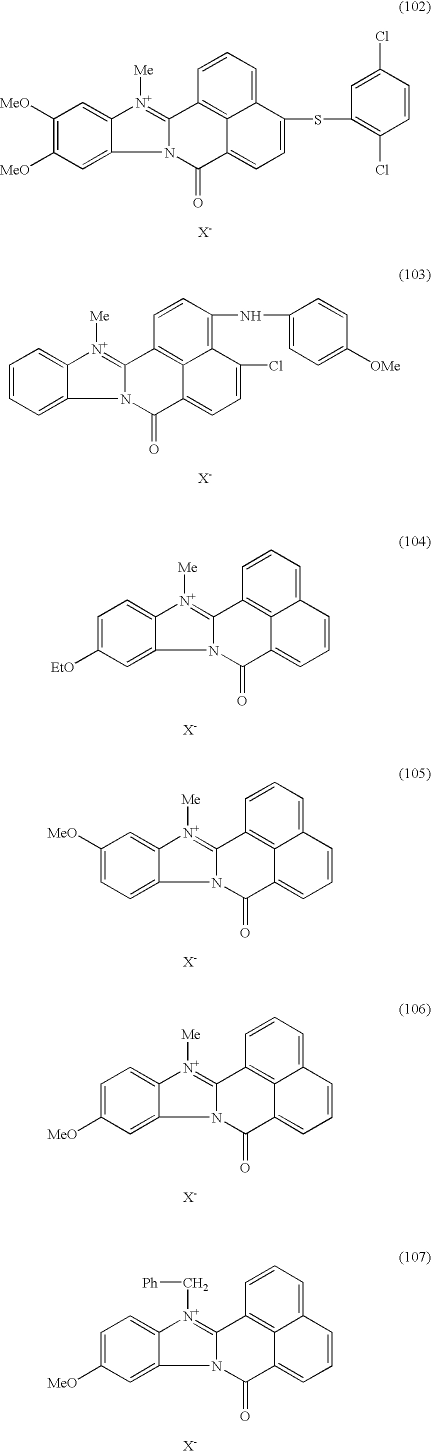

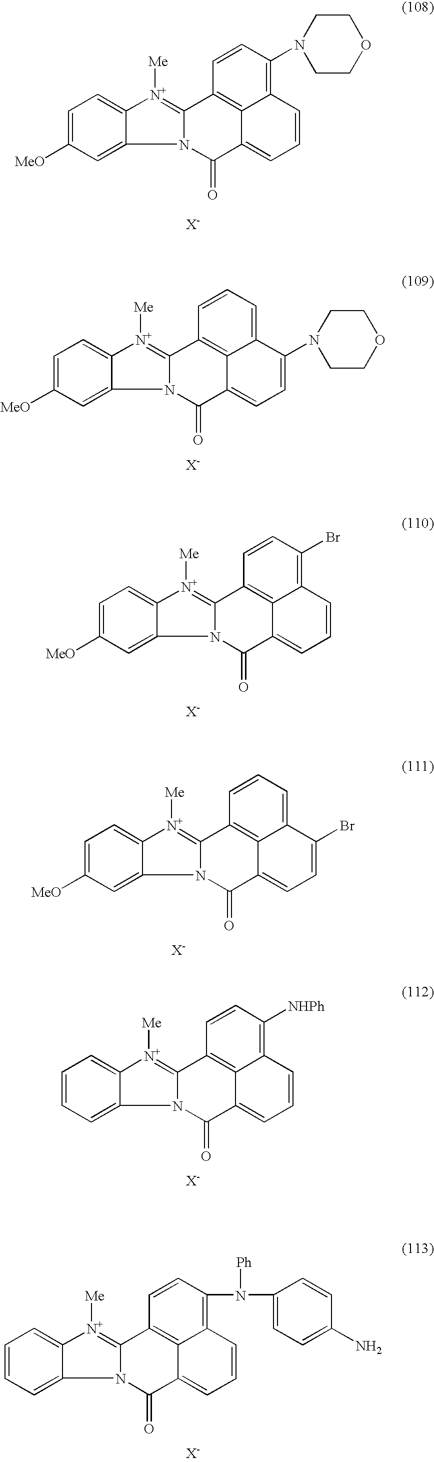

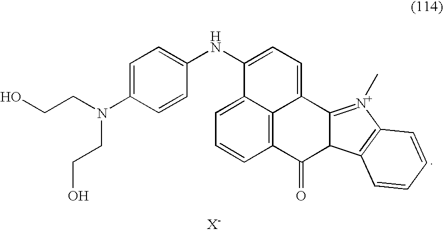

6. A dye composition according to claim 1, wherein said at least one direct dye of formula (I) is present in an amount ranging from 0.001% to 20% by weight relative to the total weight of the composition.

7. A dye composition according to claim 6, wherein said at least one direct dye of formula (I) is present in an amount ranging from 0.1% to 10% by weight relative to the total weight of the composition.

8. A dye composition according to claim 7, wherein said at least one direct dye of formula (I) is present in an amount ranging from 0.1% to 5% by weight relative to the total weight of the composition.

9. A dye composition according to claim 1, further comprising at least one conditioning agent.

10. A dye composition according to claim 9, wherein said at least one conditioning agent is chosen from cationic polymers, cations, silicones, chitosans and chitosan derivatives.

11. A dye composition according to claim 1, further comprising at least one thickening polymer.

12. A dye composition according to claim 1, further comprising at least one surfactant chosen from anionic surfactants, amphoteric surfactants, zwitterionic surfactants, nonionic surfactants and cationic surfactants.

13. A dye composition according to claim 1, further comprising at least one oxidation dye precursor chosen from oxidation bases and couplers.

14. A dye composition according to claim 13, wherein said oxidation bases are chosen from para-phenylenediamines, bis(phenyl)alkylenediamines, para-aminophenols, ortho-aminophenols and heterocyclic bases, and the addition salts thereof.

15. A dye composition according to claim 13, wherein, when present, said at least one oxidation base is present in an amount ranging from 0.001% to 20% by weight relative to the total weight of the composition.

16. A dye composition according to claim 15, wherein said at least one oxidation base is present in an amount ranging from 0.005% to 6% by weight relative to the total weight of the composition.

17. A dye composition according to claim 13, wherein said couplers are chosen from meta-phenylenediamines, meta-aminophenols, meta-diphenols, naphthalene-based couplers and heterocyclic couplers, and the addition salts thereof.

18. A dye composition according to claim 17, wherein said couplers are chosen from 1,3-dihydroxybenzene, 1,3-dihydroxy-2-methylbenzene, 4-chloro-1,3-dihydroxybenzene, 2,4-diamino-1-(β-hydroxyethyloxy)benzene, 2-amino-4-(β-hydroxyethylamino)-1-methoxybenzene, 1,3-diaminobenzene, 1,3-bis(2,4-diaminophenoxy)propane, 3-ureidoaniline, 3-ureido-1-dimethylaminobenzene, sesamol, 1-β-hydroxyethylamino-3,4-methylenedioxybenzene, α-naphthol, 2-methyl-1-naphthol, 6-hydroxyindole, 4-hydroxyindole, 4-hydroxy-N-methylindole, 2-amino-3-hydroxypyridine, 6-hydroxybenzomorpholine, 3,5-diamino-2,6-dimethoxypyridine, 1-N-(β-hydroxyethyl)amino-3,4-methylenedioxybenzene and 2,6-bis(β-hydroxyethylamino)toluene, and the addition salts thereof.

19. A dye composition according to claim 13, wherein, when present, said at least one coupler is present in an amount ranging from 0.001% to 20% by weight relative to the total weight of the composition.

20. A dye composition according to claim 19, wherein said at least one coupler is present in an amount ranging from 0.005% to 6% by weight relative to the total weight of the composition.

21. A dye composition according to claim 1, further comprising at least one additional direct dye.

22. A dye composition according to claim 1, further comprising at least one hydroxylated solvent

23. A dye composition according to claim 22, wherein said at least one hydroxylated solvent is chosen from ethanol, propylene glycol, glycerol, and polyol monoethers.

24. A dye composition according to claim 21, wherein said at least one hydroxylated solvent is chosen from ethanol, propylene glycol, glycerol and polyol monoethers.

25. A dye composition according to claim 1, further comprising at least one oxidizing agent chosen from hydrogen peroxide, urea peroxide, alkali metal bromates, persalts, peracids and oxidase enzymes.

26. A dye composition according to claim 25, wherein said at least one oxidizing agent is hydrogen peroxide.

27. A process for dyeing keratin fibers, comprising applying a dye composition to the keratin fibers, and then leaving it to act for a period ranging from 5 minutes to 1 hour,
wherein the dye composition comprises, in a suitable dyeing medium, at least one direct dye of formula (I): 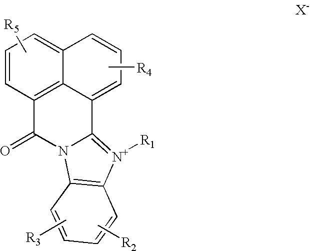
wherein:
R₁ is chosen from a linear or branched C₁-C₁₀ alkyl group and a linear or branched aryl(C₁-C₁₀)alkyl group;
R₂ and R₃ are independently chosen from a hydrogen atom, linear or branched C₁-C₁₀ alkyl groups, linear or branched C₁-C₁₀ alkoxy groups, halogen atoms, (C₁-C₁₀)alkoxycarbonyl groups, and CF₃;
R₄ and R₅ are independently chosen from a hydrogen atom, halogen atoms, linear or branched C₁-C₁₀ alkyl groups, linear or branched C₁-C₁₀ alkoxy groups, hydroxyl groups, amino groups, linear or branched C₁-C₁₀ alkylamino groups, linear or branched C₁-C₁₀ dialkylamino groups, phenylamino groups, diphenylamino groups, (C₁-C₄)alkylaminophenylamino groups, aminophenylaminophenyl groups, linear or branched C₁-C₁₀ alkylthio groups, phenylthio groups, (C₁-C₁₀)alkylphenylthio groups, (C₁-C₁₀)alkoxyphenylthio groups, phenyl(C₁-C₄)alkylthio groups, and morpholino groups, or R₄ and R₅ together form a 5- to 12-membered aromatic or heterocyclic ring; and
X⁻ is a counterion of a mineral acid or an organic acid.

28. A process according to claim 27, wherein said dye composition is left to act for a period ranging from 15 minutes to 1 hour.

29. A process for obtaining, on keratin fibers, strong, sparingly selective, and colorfast shades, said process comprising applying a dye composition to the keratin fibers,
wherein the dye composition comprises, in a suitable dyeing medium, at least one direct dye of formula (I): 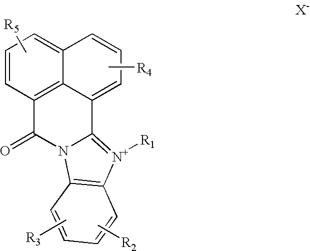
wherein:
R₁ is chosen from a linear or branched C₁-C₁₀ alkyl group and a linear or branched aryl(C₁-C₁₀)alkyl group;
R₂ and R₃ are independently chosen from a hydrogen atom, linear or branched C₁-C₁₀ alkyl groups, linear or branched C₁-C₁₀ alkoxy groups, halogen atoms, (C₁-C₁₀)alkoxycarbonyl groups, and CF₃;
R₄ and R₅ are independently chosen from a hydrogen atom, halogen atoms, linear or branched C₁-C₁₀ alkyl groups, linear or branched C₁-C₁₀ alkoxy groups, hydroxyl groups, amino groups, linear or branched C₁-C₁₀ alkylamino groups, linear or branched C₁-C₁₀ dialkylamino groups, phenylamino groups, diphenylamino groups, (C₁-C₄)alkyl-aminophenylamino groups, aminophenylaminophenyl groups, linear or branched C₁-C₁₀ alkylthio groups, phenylthio groups, (C₁-C₁₀)alkylphenylthio groups, (C₁-C₁₀)alkoxyphenylthio groups, phenyl(C₁-C₄)alkylthio groups, and morpholino groups, or R₄ and R₅ together form a 5- to 12-membered aromatic or heterocyclic ring; and
X⁻ is a counterion of a mineral acid or an organic acid,
and wherein said at least one direct dye is present in the composition in an amount sufficient to produce strong, sparingly selective, and colorfast shades on said fibers.
